(19) United States
(12) Patent Application Publication
(10) Pub. No.: US 2026/0029594 A1
(43) Pub. Date: Jan. 29, 2026

(54) OPTICAL MODULE

(71) Applicant: HISENSE BROADBAND MULTIMEDIA TECHNOLOGIES CO., LTD., Qingdao (CN)

(72) Inventors: Long ZHENG, Qingdao (CN); Wanju SUN, Qingdao (CN); Liang CAO, Qingdao (CN); Sigeng YANG, Qingdao (CN)

(21) Appl. No.: 19/341,659

(22) Filed: Sep. 26, 2025

Related U.S. Application Data
(63) Continuation of application No. PCT/CN2023/139032, filed on Dec. 15, 2023.

(30) Foreign Application Priority Data
Jun. 30, 2023 (CN) 202310798498.X
Jun. 30, 2023 (CN) 202310800649.0
Sep. 21, 2023 (CN) 202311227398.8
Sep. 21, 2023 (CN) 202311227445.9

(51) Int. Cl. G02B 6/42

(52) U.S. Cl. CPC G02B 6/426; G02B 6/4204; G02B 6/423; G02B 6/4269; G02B 6/4281; G02B 6/4286

(57) ABSTRACT

An optical module comprising upper and lower shell parts, a circuit board and an optical connection component. The cavity formed by the upper and lower shell parts has only one opening for accommodating the optical connection component and golden fingers on the circuit board. The optical connection component comprises an optical fiber fixing member, a connecting member and a ferrule assembly. The optical fiber fixing member comprises a connection part and an insertion part. An accommodation cavity for inserting the connecting member is formed inside the connection part, and a cavity communicated with the accommodation cavity is formed inside the insertion part. The ferrule assembly is inserted into the cavity via the connecting member, and the optical fiber passes through the accommodation cavity and is connected to the ferrule assembly. An avoidance gap is formed on the connecting member, through which the optical fiber ribbon is passed.

The present disclosure is a continuation of International Application No. PCT/CN2023/139032, filed on Dec. 15, 2023, which claims priority to Chinese Patent Application No. 202311227398.8, filed with the China National Intellectual Property Administration on Sep. 21, 2023, priority to Chinese Patent Application No. 202311227445.9, filed with the China National Intellectual Property Administration on Sep. 21, 2023, priority to Chinese Patent Application No. 202310798498.X, filed with the China National Intellectual Property Administration on Jun. 30, 2023, and priority to Chinese Patent Application No. 202310800649.0, filed with the China National Intellectual Property Administration on Jun. 30, 2023. All above-mentioned applications are hereby incorporated by reference in their entirety.

### FIELD OF THE INVENTION

The present disclosure relates to the field of optical communication technology, and in particular, to an optical module.

### BACKGROUND OF THE INVENTION

Optical communication technology is widely used in new services and application models such as cloud computing, mobile Internet, and video. In optical communication, the optical module is a device that enables the conversion between optical and electrical signals, and it is one of the key devices in optical communication equipment.

### SUMMARY OF THE INVENTION

An optical module is provided according to embodiments of the present disclosure and includes:
a lower shell part;
an upper shell part that is covered on the lower shell part to form a cavity, the cavity having only one opening;
a circuit board disposed in the cavity, one end of the circuit board being disposed with a golden finger;
an optical component that is electrically connected to the circuit board, the optical component being configured to generate or receive an optical signal;
an optical connection component that is mounted on the circuit board, where the optical connection component and the golden finger are located at the opening; the optical connection component is optically connected to the optical component via an optical fiber ribbon; the optical connection component is configured to transmit an optical signal; and where the optical connection component includes:
an optical fiber fixing member including a connection part and an insertion part connected to each other, where the connection part is mounted on the circuit board, and is formed therein with an accommodation cavity, two ends of the accommodation cavity being formed with insertion openings; the insertion part is formed therein with a cavity that is opened at two ends and is communicated with the accommodation cavity;
a ferrule assembly that is inserted into the cavity through the insertion openings, where the optical fiber passes through the accommodation cavity and is optically connected to the ferrule assembly;
a connecting member that is inserted in the accommodation cavity through corresponding insertion opening, where the connecting member is fixedly connect with the ferrule assembly and is fixed in the accommodation cavity such that the ferrule assembly is mounted in the cavity through the connecting member; and the connecting member is formed thereon with an avoidance gap, and the optical fiber ribbon is passed through the avoidance gap.

### BRIEF DESCRIPTION OF THE DRAWINGS

To illustrate the technical solutions in the present disclosure more clearly, a brief introduction to the drawings that need to be used in some embodiments of the present disclosure will be provided below. Apparently, the drawings described below are merely the drawings in some embodiments of the present disclosure. Those of ordinary skill in the art can also derive other drawings from these drawings. Furthermore, the drawings described below can be regarded as schematic diagrams and are not intended to limit the actual dimensions of the products, the actual processes of the methods, or the actual timing of the signals involved in the embodiments of the present disclosure.

FIG. 1 is a partial structural diagram of an optical communication system provided according to some embodiments of the present disclosure;

FIG. 2 is a partial structural diagram of a host computer provided according to some embodiments of the present disclosure;

FIG. 3 is a structural diagram of an optical module provided according to some embodiments of the present disclosure;

FIG. 4 is an exploded view of an optical module provided according to some embodiments of the present disclosure;

FIG. 5 is a partial structural diagram of an optical module provided according to some embodiments of the present disclosure;

FIG. 6 is a partial exploded view of an optical module provided according to some embodiments of the present disclosure;

FIG. 7 is a structural diagram of a circuit board in an optical module provided according to some embodiments of the present disclosure;

FIG. 8 is a partial exploded view of an optical emission component and a circuit board in an optical module provided according to some embodiments of the present disclosure;

FIG. 9 is a structural diagram of an optical emission component in an optical module provided according to some embodiments of the present disclosure;

FIG. 10 is a partial structural diagram of an optical emission component in an optical module provided according to some embodiments of the present disclosure;

FIG. 11 is a structural diagram of a fixing base in an optical module provided according to some embodiments of the present disclosure;

FIG. 12 is a partial top view of an optical emission component in an optical module provided according to some embodiments of the present disclosure;

FIG. 13 is a first assembly cross-sectional view of an optical emission component and a circuit board in an optical module provided according to some embodiments of the present disclosure;

FIG. 14 is a second assembly cross-sectional view of an optical emission component and a circuit board in an optical module provided according to some embodiments of the present disclosure;

FIG. 15 is another structural diagram of a first optical emission component in an optical module provided according to some embodiments of the present disclosure;

FIG. 16 is another partial structural diagram of a first optical emission component in an optical module provided according to some embodiments of the present disclosure;

FIG. 17 is a structural diagram of a first emission housing in an optical module provided according to some embodiments of the present disclosure;

FIG. 18 is another cross-sectional view of a first optical emission component in an optical module provided according to some embodiments of the present disclosure;

FIG. 19 is an emission optical path diagram of a first optical emission component in an optical module provided according to some embodiments of the present disclosure;

FIG. 20 is a structural diagram of a photodetector in an optical module provided according to some embodiments of the present disclosure;

FIG. 21 is a structural diagram of a photodetector from another angle in an optical module provided according to some embodiments of the present disclosure;

FIG. 22 is an assembly cross-sectional view of a circuit board, a first optical emission component, and a second optical emission component in an optical module provided according to some embodiments of the present disclosure;

FIG. 23 is a structural diagram of an optical connection component in an optical module provided according to some embodiments of the present disclosure;

FIG. 24 is an exploded view of an optical connection component in an optical module provided according to some embodiments of the present disclosure;

FIG. 25 is a first structural diagram of an optical fiber fixing member in an optical module provided according to some embodiments of the present disclosure;

FIG. 26 is a second structural diagram of an optical fiber fixing member in an optical module provided according to some embodiments of the present disclosure;

FIG. 27 is a third structural diagram of an optical fiber fixing member in an optical module provided according to some embodiments of the present disclosure;

FIG. 28 is a structural diagram of a support bracket in an optical module provided according to some embodiments of the present disclosure;

FIG. 29 is a first cross-sectional view of an optical connection component in an optical module provided according to some embodiments of the present disclosure;

FIG. 30 is a first structural diagram of a connecting member in an optical module provided according to some embodiments of the present disclosure;

FIG. 31 is a second structural diagram of a connecting member in an optical module provided according to some embodiments of the present disclosure;

FIG. 32 is a second cross-sectional view of an optical connection component in an optical module provided according to some embodiments of the present disclosure;

FIG. 33 is a third cross-sectional view of an optical connection component in an optical module provided according to some embodiments of the present disclosure;

FIG. 34 is a structural diagram of a cover in an optical module provided according to some embodiments of the present disclosure; and

FIG. 35 is a third cross-sectional view of an optical connection component in an optical module provided according to some embodiments of the present disclosure.

### DETAILED DESCRIPTION OF THE EMBODIMENTS

The following describes some embodiments of the present disclosure clearly and in detail with reference to the drawings. However, the described embodiments are some but not all of the embodiments of the present disclosure. All other embodiments obtained by those of ordinary skill in the art based on the embodiments provided in the present disclosure fall within the scope of protection of the present disclosure.

Unless otherwise required by the context, throughout the specification and the claims, the term “include/comprise” is interpreted as open and inclusive, meaning “including/comprising, but not limited to”; the terms “first” and “second” should not be construed as indicating or implying relative importance or indicating an upper limit on quantity; the term “a plurality of” means two or more; the term “connection” should be understood broadly, for example, “connection” may be a fixed connection, a detachable connection, or an integral connection, or may be directly connected, or indirectly connected via an intermediate medium; the term “adapted to” or “configured to” is open and inclusive language, and does not exclude devices adapted or configured to perform additional tasks or steps; and the terms “parallel,” “vertical,” “same,” “consistent,” “flush,” etc. are not limited to absolute mathematical theoretical relationships, but also include acceptable error ranges arising in practice, as well as differences formed due to manufacturing reasons based on the same design concept.

In optical communication technology, in order to establish information transmission between information processing devices, it is necessary to load information onto light and use the propagation of light to achieve the transmission of information. Here, the light loaded with information is an optical signal. When the optical signal is transmitted in the information transmission devices, the loss of optical power can be reduced, such that high-speed, long-distance, and low-cost information transmission can be achieved. The signals that the information processing devices are able to recognize and process are electrical signals. The information processing devices usually include optical network units (ONUs), gateways, routers, switches, mobile phones, computers, servers, tablet computers, televisions, etc. The information transmission devices usually include optical fibers and optical waveguides.

The optical modules enable the conversion between optical signals and electrical signals from the information processing devices and the information transmission devices. For example, at least one of an optical signal input or an optical signal output of an optical module is connected to an optical fiber, and at least one of an electrical signal input or an electrical signal output of the optical module is connected to an optical network unit; a first optical signal from the optical fiber is transmitted to the optical module, and the optical module converts the first optical signal into a first electrical signal and transmits the first electrical signal to the optical network unit; and a second electrical signal from the optical network unit is transmitted to the optical module, and the optical module converts the second electrical signal into a second optical signal and transmits the second optical signal to the optical fiber. Since information can be transmitted through electrical signals between a plurality of information processing devices, at least one information processing device in the plurality of information processing devices is required to be directly connected to the optical module, and all information processing devices are not required to be directly connected to the optical module. Here, the information processing device directly connected to the optical module is referred to as a host computer of the optical module. In addition, the optical signal input or the optical signal output of the optical module can be referred to as an optical port, and the electrical signal input or the electrical signal output of the optical module can be referred to as an electrical port.

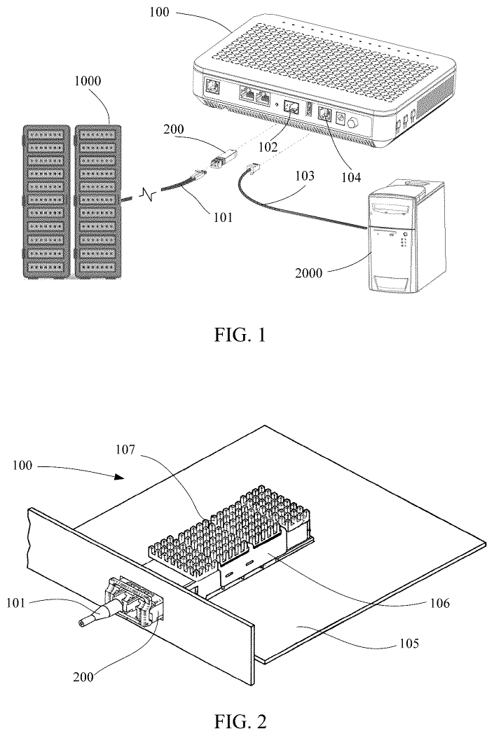

FIG. 1 is a partial structural diagram of an optical communication provided system according to some embodiments of the present disclosure. As shown in FIG. 1, the optical communication system primarily includes a remote information processing device 1000, a local information processing device 2000, a host computer 100, an optical module 200, an optical fiber 101 and a network cable 103.

One end of the optical fiber 101 extends in the direction of the remote information processing device 1000, and the other end of the optical fiber 101 is connected to the optical module 200 via an optical port of the optical module 200. An optical signal can undergo total reflection in the optical fiber 101, and the propagation of the optical signal in the total reflection direction can nearly maintain original optical power. The optical signal undergoes multiple total reflections in the optical fiber 101 to transmit an optical signal from the remote information processing device 1000 to the optical module 200 or to transmit an optical signal from the optical module 200 to the remote information processing device 1000, thereby achieving long-distance and low-power-loss information transmission.

The optical communication system may include one or more optical fibers 101, and the optical fiber 101 is detachably or fixedly connected to the optical module 200. The host computer 100 is configured to provide a data signal to the optical module 200, receive a data signal from the optical module 200, or monitor or control a working state of the optical module 200.

The host computer 100 includes a generally cuboid-shaped shell and an optical module interface 102 arranged on the shell. The optical module interface 102 is configured to be connected to the optical module 200, enabling the host computer 100 to establish a one-way or two-way electrical signal connection with the optical module 200.

The host computer 100 further includes an external electrical interface that can be connected to an electrical signal network. For example, the external electrical interface includes a universal serial bus (USB) interface or a network cable interface 104. The network cable interface 104 is configured to be connected to the network cable 103, enabling the host computer 100 to establish a one-way or two-way electrical signal connection with the network cable 103. One end of the network cable 103 is connected to the local information processing device 2000, and the other end of the network cable 103 is connected to the host computer 100, thereby establishing an electrical signal connection between the local information processing device 2000 and the host computer 100 via the network cable 103. For example, a third electrical signal sent by the local information processing device 2000 is transmitted to the host computer 100 via the network cable 103. The host computer 100 generates a second electrical signal according to the third electrical signal. The second electrical signal from the host computer 100 is transmitted to the optical module 200. The optical module 200 converts the second electrical signal into a second optical signal and transmits the second optical signal to the optical fiber 101. The second optical signal is transmitted through the optical fiber 101 to the remote information processing device 1000. For example, a first optical signal from the remote information processing device 1000 is transmitted through the optical fiber 101. The first optical signal from the optical fiber 101 is transmitted to the optical module 200. The optical module 200 converts the first optical signal into a first electrical signal, and then the optical module 200 transmits the first electrical signal to the host computer 100. The host computer 100 generates a fourth electrical signal according to the first electrical signal and transmits the fourth electrical signal to the local information processing device 2000. It should be noted that the optical module is a tool to achieve the conversion between optical signals and electrical signals. In the conversion between the optical signals and the electrical signals, the information remains unchanged, and the encoding and decoding methods for the information may vary.

In addition to the optical network unit, the host computer 100 further includes an optical line terminal (OLT), an optical network terminal (ONT), or a data center server.

FIG. 2 is a partial structural diagram of a host computer provided according to some embodiments of the present disclosure. To clearly show the connection relationship between the optical module 200 and the host computer 100, FIG. 2 shows only the structure of the host computer 100 related to the optical module 200. As shown in FIG. 2, the host computer 100 further includes a printed circuit board (PCB) 105 arranged in the shell, a cage 106 arranged on the surface of the PCB 105, a heat sink 107 arranged on the cage 106, and an electrical connector arranged inside the cage 106. The electrical connector is configured to be connected to the electrical port of the optical module 200. The heat sink 107 has protruding structures such as fins that enlarge the heat dissipation area.

The optical module 200 is inserted into the cage 106 of the host computer 100, and the optical module 200 is fixed by the cage 106. Heat generated by the optical module 200 is conducted to the cage 106 and then diffused through the heat sink 107. After the optical module 200 is inserted into the cage 106, the electrical port of the optical module 200 is connected to the electrical connector inside the cage 106, such that the optical module 200 establishes a two-way electrical signal connection with the host computer 100. In addition, the optical port of the optical module 200 is connected to the optical fiber 101, thereby establishing a bidirectional optical signal connection between the optical module 200 and the optical fiber 101.

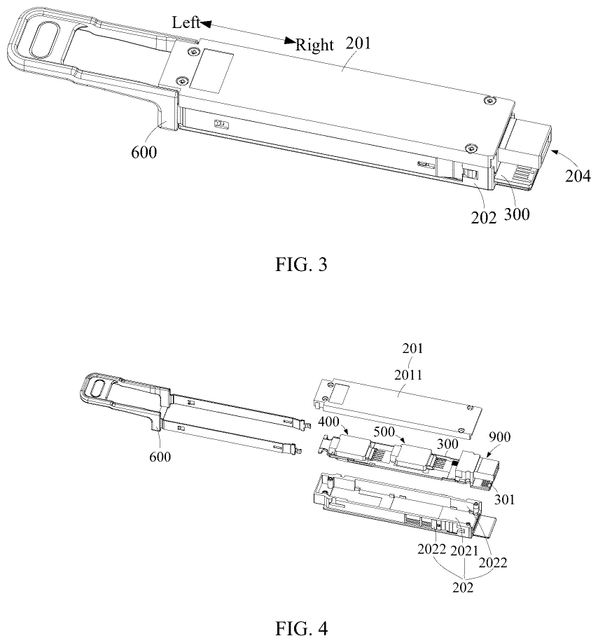

FIG. 3 is a structural diagram of an optical module provided according to some embodiments of the present disclosure, and FIG. 4 is an exploded view of an optical module provided according to some embodiments of the present disclosure. As shown in FIG. 3 and FIG. 4, the optical module 200 includes a shell, a circuit board 300 arranged inside the shell, an optical emission component 400, an optical reception component 500, and an optical connection component 900. In some embodiments, the optical emission component 400 and the optical reception component 500 may also be referred to as optical components. However, the present disclosure is not limited thereto. In some embodiments, the optical module 200 includes either the optical emission component 400 or the optical reception component 500.

The shell includes an upper shell part 201 and a lower shell part 202, where the upper shell part 201 covers the lower shell part 202 to form the shell with at least one open end (right end opening 204 and/or left end opening); and the outer contour of the shell is generally square.

In some embodiments, the lower shell part 202 includes a bottom plate 2021 and two lower side plates 2022 located at both sides of the bottom plate 2021 and perpendicular to the bottom plate 2021; and the upper shell part 201 includes a cover plate 2011, where the cover plate 2011 covers the two lower side plates 2022 of the lower shell part 202 to form the shell.

In some embodiments, the lower shell part 202 includes a bottom plate 2021 and two lower side plates 2022 located at two sides of the base plate 2021 and perpendicular to the bottom plate 2021; and the upper shell part 201 includes a cover plate 2011 and two upper side plates located at two sides of the cover plate 2011 and perpendicular to the cover plate 2011, where the two upper side plates and the two lower side plates 2022 are combined to ensure that the upper shell part 201 covers the lower shell part 202.

The direction of a connecting line between the two openings may be consistent with the length direction of the optical module 200 or may be inconsistent with the length direction of the optical module 200. For example, the opening 204 is located at the end of the optical module 200 (the right end in FIG. 3), and the opening formed by the optical connection component 900 is also located at the end of the optical module 200 (the right end in FIG. 3), that is, the optical module 200 has only one opening 204. The opening 204 serves as an electrical port, and the golden fingers 301 of the circuit board 300 extend from the electrical port and are inserted into the electrical connector of the host computer 100; the opening 204 also serves as an optical port, and is configured to be inserted into the optical connector of the host computer 100, enabling the optical components in the optical module 200 to be connected to the optical connector inside the host computer 100.

An assembly method of combining the upper shell part 201 with the lower shell part 202 is adopted, such that the circuit board 300, the optical emission component 400, the optical reception component 500, the optical connection component 900, and other components can be conveniently mounted in the shell, and these devices can be packaged by the upper shell part 201 and lower shell part 202 for protection. In addition, when the circuit board 300, the optical emission component 400, the optical reception component 500, the optical connection component 900, and other components are assembled, the assembly method of combining the upper shell part 201 with the lower shell part 202 facilitates the deployment of positioning components, heat dissipation components, and electromagnetic shielding components for these devices, which is conducive to automated production.

In some embodiments, the upper shell part 201 and the lower shell part 202 are made of metal materials, which is conducive to electromagnetic shielding and heat dissipation.

In some embodiments, the optical module 200 further includes an unlocking component 600 located outside its shell. The unlocking component 600 is configured to achieve a fixed connection between the optical module 200 and the host computer 100, or to release the fixed connection between the optical module 200 and the host computer 100.

For example, the unlocking component 600 is located outside the two lower side plates 2022 of the lower shell part 202, and includes a clamping component that matches the cage 106 of the host computer 100. When the optical module 200 is inserted into the cage 106, the optical module 200 is fixed in the cage 106 by the clamping component of the unlocking component 600; and when the unlocking component 600 is pulled, the clamping component of the unlocking component 600 moves accordingly, such that the connection relationship between the clamping component and the host computer is changed to release the fixation of the optical module 200 to the host computer, thereby pulling out the optical module 200 from the cage 106.

The circuit board 300 includes circuit traces, electronic components, and chips, where the electronic components and the chips are connected according to the circuit design through the circuit traces to implement the functions such as power supply, electrical signal transmission and grounding. The electronic components may include, for example, capacitors, resistors, transistors, and metal-oxide-semiconductor field-effect transistors (MOSFETs). The chips may include, for example, microcontroller units (MCUs), laser driving chips, transimpedance amplifiers (TIAs), limiting amplifiers (LAs), clock and data recovery (CDR) chips, power management chips, and digital signal processing (DSP) chips.

The circuit board 300 is generally a rigid circuit board. The rigid circuit board can also achieve the bearing effect because of its relatively hard material, for example, the rigid circuit board can smoothly carry the above-mentioned electronic components and chips. The rigid circuit board can also be inserted into the electrical connector in the cage 106 of the host computer 100.

The circuit board 300 further includes golden fingers 301 formed on the end surface thereof, where each golden finger 301 includes a plurality of independent pins. The circuit board 300 is inserted into the cage 106, and the golden fingers 301 are connected to the electrical connector in the cage 106. The golden finger 301 may be arranged only on the surface of a side of the circuit board 300 (for example, the upper surface shown in FIG. 4), or may be arranged on the surfaces of the upper and lower sides of the circuit board 300 to provide more pins, so as to adapt to the occasion where a large number of pins are required. The golden finger 301 is configured to establish an electrical connection with the host computer to achieve power supply, grounding, two-wire inter-integrated circuit (I2C) signal transmission, data signal transmission, etc. Certainly, flexible circuit boards are also used in some optical modules. Flexible circuit boards are generally used in conjunction with rigid circuit boards as a supplement to rigid circuit boards.

At least one of the optical emission component 400 or the optical reception component 500 is located on a side of the circuit board 300 away from the golden fingers 301.

In some embodiments, the optical emission component 400 and the optical reception component 500 are physically separated from the circuit board 300 and then are electrically connected to the circuit board 300 via corresponding flexible circuit boards or electrical connectors.

In some embodiments, at least one of the optical emission component 400 or the optical reception component 500 may be directly arranged on the circuit board 300. For example, at least one of the optical emission component 400 or the optical reception component 500 may be arranged on a surface of the circuit board 300 or a side edge of the circuit board 300.

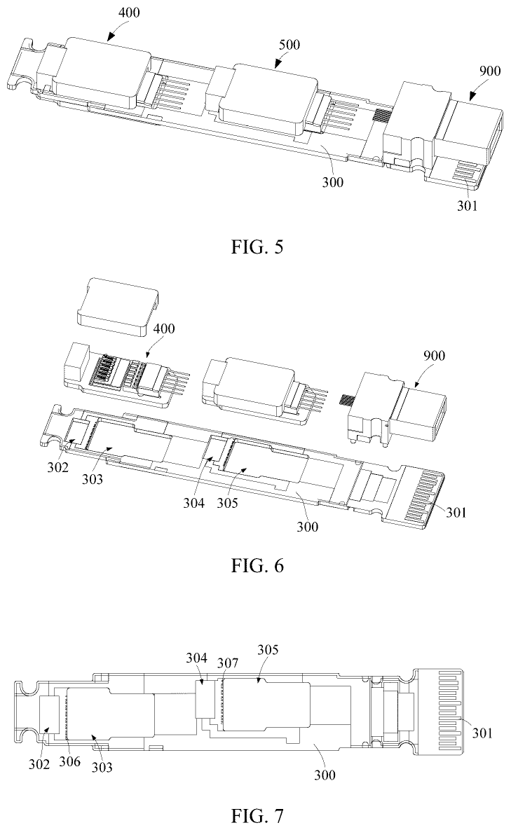

FIG. 5 is a partial structural diagram of an optical module provided according to some embodiments of the present disclosure, and FIG. 6 is a partial exploded view of an optical module provided according to some embodiments of the present disclosure. As shown in FIG. 5 and FIG. 6, the cavity formed by the upper shell part 201 and the lower shell part 202 has only one opening 204, where the golden fingers 301 are located at the opening 204. Optical components such as the optical emission component 400 and the optical reception component 500 may be arranged on the circuit board 300 in the left-right direction (in some embodiments, the optical components may also be separated from the circuit board 300; and in some embodiments of the present disclosure, the optical components are described as being arranged on the circuit board 300 as an example). The optical emission component 400 is located at an end of the circuit board 300 away from the golden fingers 301, the optical reception component 500 is located between the optical emission component 400 and the golden fingers 301, and the optical connection component 900 is located at an end of the circuit board 300 close to the golden fingers 301. The optical emission component 400 and the optical reception component 500 are connected via an optical fiber ribbon (in some embodiments, also referred to as optical fiber) and the optical connection component 900, so as to achieve the optoelectronic co-port of the optical module 200.

The electrical connector in the host computer 100 is electrically connected to the golden fingers 301 on the circuit board 300, and the host computer 100 transmits electrical signals to the circuit board 300. The optical emission component 400 generates optical signals driven by the electrical signals transmitted on the circuit board 300, the optical signals are transmitted to the optical connection component 900 via the optical fiber ribbon, and the optical connection component 900 is optically connected to the optical connector in the host computer 100. Thus, the optical signals generated by the optical emission component 400 are transmitted to the host computer 100 via the optical fiber ribbon and the optical connection component 900, so as to achieve optical emission.

The external optical signals transmitted by the host computer 100 are transmitted to the optical reception component 500 via the optical connection component 900 and the optical fiber ribbon. The optical reception component 500 converts the optical signals into electrical signals, and the electrical signals are transmitted to the host computer 100 via the golden fingers 301 on the circuit board 300, so as to achieve optical reception.

In some embodiments, to avoid mutual interference between the optical fiber ribbons connecting the optical emission component 400 and the optical reception component 500, a central axis of the optical emission component 400 and a central axis of the optical reception component 500 do not coincide, such that the optical emission component 400 and the optical reception component 500 are offset.

In some embodiments, the optical reception component 500 may be replaced by the optical emission component, that is, the optical module includes two optical emission components, where the two optical emission components together with the optical connection component 900, are arranged on the circuit board 300 in the left-right direction. The two optical emission components are respectively connected via the optical fiber ribbons and the optical connection component 900, and the optical signals emitted by the two optical emission components are transmitted to the optical connector of the host computer 100 via the optical connection component 900, so as to achieve multi-channel optical emission.

In some embodiments, to avoid mutual interference between the optical fiber ribbons connecting the two optical emission components, the central axes of the two optical emission components do not coincide, such that the two optical emission components are offset.

The optical emission component 400 may also be replaced by an optical reception component, that is, the optical module includes two optical reception components, where the two optical reception components together with the optical connection component 900, are arranged on the circuit board 300 in the left-right direction. The two optical reception components are respectively connected via the optical fiber ribbons and the optical connection component 900. The external optical signals transmitted by the host computer 100 are transmitted to the two optical reception components via the optical connection component 900 and the optical fiber ribbons. The two optical reception components convert the external optical signals into electrical signals, and the electrical signals are transmitted to the host computer 100 via the circuit board 300, so as to achieve multi-channel optical reception.

In some embodiments, to avoid mutual interference between the optical fiber ribbons connecting the two optical reception components, the central axes of the two optical reception components do not coincide, such that the two optical reception components are offset.

In some embodiments, the optical components, such as the optical emission component 400 and the optical reception component 500, or two optical emission components, or two optical reception components, may be directly arranged on the circuit board 300. A laser of the optical emission component 400 and/or a detector of the optical reception component 500 are electrically connected to the circuit board 300 via wire bonding, such that the optical emission component 400 generates the optical signals and the optical reception component 500 receives the optical signals.

In some embodiments, to ensure the layout space on the circuit board 300, the optical components may also be separated from the circuit board 300, and the optical components may be electrically connected to the circuit board 300 via flexible circuit boards.

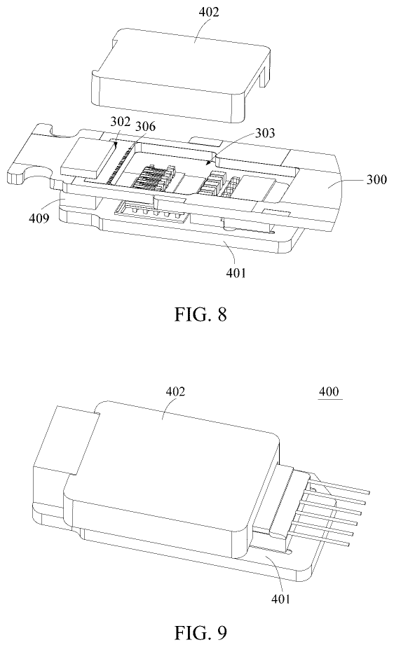

FIG. 7 is a structural diagram of a circuit board in an optical module provided according to some embodiments of the present disclosure, and FIG. 8 is a partial exploded view of an optical emission component and a circuit board in an optical module provided according to some embodiments of the present disclosure. As shown in FIG. 7 and FIG. 8, in some embodiments of the present disclosure, the optical components are described as being directly arranged on the circuit board 300 as an example. To reduce a wire bonding length between the circuit board 300 and the optical components, mounting holes are formed in the circuit board 300, and the optical components may be embedded in the mounting holes, such that a wire bonding surface of the laser or detector and other optical devices of the optical components is flush with a front surface of the circuit board 300, to reduce the loss of high-frequency signals in the optical module.

In some embodiments, a limit hole and a pad group are formed in the circuit board 300, the limit hole and the mounting hole are not communicated, and the pad group is located at a side of the mounting hole.

In some embodiments, the optical component includes a fixing base and an optical assembly. The fixing base is embedded in the mounting hole, and a top surface of the fixing base is bonded and fixed to a back surface of the circuit board. One end of the fixing base is provided with a limit boss, the limit boss protrudes from the top surface of the fixing base, and is embedded in the limit hole. The optical assembly is mounted on the fixing base and is located within the mounting hole, where a gap exists between the optical device in the optical assembly and the limit boss, a wire bonding height of the optical device is equal to a mounting height of the pad group, and the optical device is electrically connected to the pad group via wire bonding.

When the optical components of the optical module 200 include a first optical emission component and a second optical emission component, the mounting holes include a first mounting hole 303 and a second mounting hole 305 formed in the circuit board 300. The first mounting hole 303 and the second mounting hole 305 pass through front and back surfaces of the circuit board 300 and are not communicated. The first optical emission component is embedded in the first mounting hole 303, and the second optical emission component is embedded in the second mounting hole 305, such that a wire bonding surface of the laser of the first optical emission component and a wire bonding surface of the laser of the second optical emission component are flush with the front surface of the circuit board 300.

In some embodiments, the pad group includes a first pad group 306 and a second pad group 307. The first pad group 306 is provided at an edge of the circuit board 300 close to the first mounting hole 303. The laser of the first optical emission component embedded in the first mounting hole 303 is electrically connected to the first pad group 306 via wire bonding, so as to achieve the electrical connection between the laser and the circuit board 300 and to drive the first optical emission component to generate multi-channel laser beams.

The second pad group 307 is provided at an edge of the circuit board 300 close to the second mounting hole 305. The laser of the second optical emission component embedded in the second mounting hole 305 is electrically connected to the second pad group 307 via wire bonding, so as to achieve the electrical connection between the laser and the circuit board 300 and to drive the second optical emission component to generate multi-channel laser beams.

In some embodiments, when the first optical emission component is embedded in the first mounting hole 303 and the second optical emission component is embedded in the second mounting hole 305, the first optical emission component may be entirely embedded in the first mounting hole 303, and the second optical emission component may be entirely embedded in the second mounting hole 305. The first optical emission component may also be partially embedded in the first mounting hole 303, and the second optical emission component may also be partially embedded in the second mounting hole 305.

When the first optical emission component is partially embedded in the first mounting hole 303 and the second optical emission component is partially embedded in the second mounting hole 305, to limit positions of the first optical emission component and the second optical emission component, the limit holes include a first limit hole 302 and a second limit hole 304 formed in the circuit board 300. The first mounting hole 303 is located between the first limit hole 302 and the second mounting hole 305, while the second limit hole 304 is located between the first mounting hole 303 and the second mounting hole 305. The first pad group 306 is positioned between the first limit hole 302 and the first mounting hole 303. A limit component of the first optical emission component is embedded in the first limit hole 302, and the optical emission assembly of the first optical emission component is embedded in the first mounting hole 303, such that the first optical emission component is limited by the first limit hole 302, and a distance between the laser of the first optical emission component and the first pad group 306 on the circuit board 300 is reduced.

The second pad group 307 is located between the second limit hole 304 and the second mounting hole 305. A limit component of the second optical emission component is embedded in the second limit hole 304, and the optical emission assembly of the second optical emission component is embedded in the second mounting hole 305, such that the second optical emission component is limited by the second limit hole 304, and a distance between the laser of the second optical emission component and the second pad group 307 on the circuit board 300 is reduced.

Referring to FIG. 8, when the first optical emission component is partially embedded in the first mounting hole 303, the first optical emission component is arranged below the circuit board 300, and then moved from bottom to top, such that the limit component of the first optical emission component is embedded in the first limit hole 302, and the optical emission assembly of the first optical emission component is embedded in the first mounting hole 303, until the shell of the first optical emission component is adhesively fixed to a back surface of the circuit board 300.

When the second optical emission component is partially embedded in the second mounting hole 305, the second optical emission component is arranged below the circuit board 300, and then moved from bottom to top, such that the limit component of the second optical emission component is embedded in the second limit hole 304, and the optical emission assembly of the second optical emission component is embedded in the second mounting hole 305, until the shell of the second optical emission component is adhesively fixed to the back surface of the circuit board 300.

In some embodiments, a width of the first mounting hole 303 (dimension perpendicular to the left-right direction) may be greater than a width of the first limit hole 302, and a length of the first mounting hole 303 (dimension in the left-right direction) may be greater than a length of the first limit hole 302. A width of the second mounting hole 305 may be greater than a width of the second limit hole 304, and a length of the second mounting hole 305 may be greater than a length of the second limit hole 304.

A width of the first mounting hole 303 may also be equal to the width of the second mounting hole 305, and the length of the first mounting hole 303 may also be equal to a length of the second mounting hole 305. The width of the first limit hole 302 may also be equal to the width of the second limit hole 304, and the length of the first limit hole 302 may also be equal to the length of the second limit hole 304.

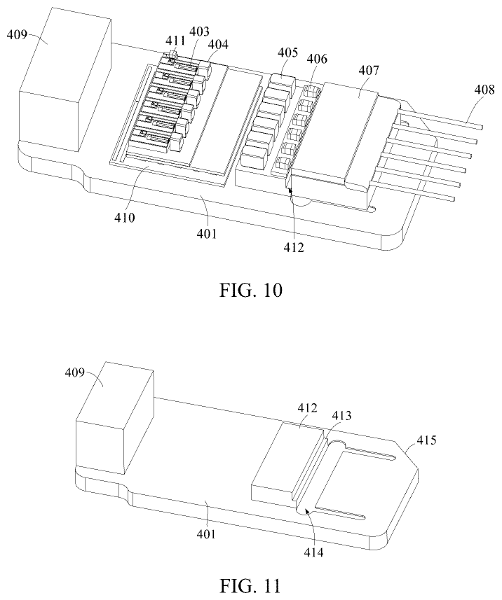

FIG. 9 is a structural diagram of an optical emission component in an optical module provided according to some embodiments of the present disclosure, and FIG. 10 is a partial structural diagram of an optical emission component in an optical module provided according to some embodiments of the present disclosure. As shown in FIG. 9 and FIG. 10, when the optical module 200 includes a first optical emission component and a second optical emission component, the first optical emission component and the second optical emission component have a same configuration. In some embodiments of the present disclosure, the first optical emission component is described as a specific example. In some examples of the embodiments of the present disclosure, the first optical emission component includes a fixing base 401, a cover 402, and an optical emission assembly (namely, optical assembly). The cover 402 is covered on the fixing base 401 to form an emission cavity, and the optical emission assembly is positioned in the emission cavity.

A width of the fixing base 401 may be less than or equal to the width of the first mounting hole 303. A limit boss 409 is provided at an end of the fixing base 401 away from the golden fingers 301. The limit boss 409 is embedded in the first limit hole 302, and a right end of the fixing base 401 is embedded in the first mounting hole 303. A side face of the fixing base 401 may be adhesively fixed to a side wall of the first mounting hole 303, such that the optical emission assembly mounted on the fixing base 401 is located in the first mounting hole 303.

In some embodiments, the top surface of the fixing base 401 may also be fixed to the back surface of the circuit board 300, that is, the width of the fixing base 401 is greater than the width of the first mounting hole 303. Part of the top surface of the fixing base 401 is exposed through the first mounting hole 303, such that the optical emission assembly can be mounted on the exposed fixing base 401, enabling the optical emission assembly to be embedded in the first mounting hole 303. The limit boss 409 is arranged at the end (left end) of the fixing base 401 away from the golden fingers 301 and protrudes from the top surface of the fixing base 401; and the limit boss 409 is embedded in the first limit hole 302 so as to limit the first optical emission component by the limit boss 409.

The optical emission assembly includes a laser group 403, a collimating lens group 404, and a first optical fiber bracket 407. The laser group 403, the collimating lens group 404, and the first optical fiber bracket 407 are sequentially mounted on the fixing base 401 in the left-right direction. The laser group 403 is located on the left side of the fixing base 401 and close to the limit boss 409. A gap exists between the laser group 403 and the limit boss 409 in the left-right direction, and corresponds to a gap between the first limit hole 302 and the first mounting hole 303, such that the laser group 403 is close to the first pad group 306.

The top surface of the fixing base 401 is adhered and fixed to the back surface of the circuit board 300, and the limit boss 409 is embedded in the first limit hole 302. After the optical emission assembly mounted on the fixing base 401 is embedded in the first mounting hole 303, the laser group 403 is close to the first pad group 306, and the wire bonding surface of the laser group 403 is flush with the top surface of the circuit board 300, such that the laser group 403 is electrically connected to the first pad group 306 via wire bonding.

The first optical fiber bracket 407 is fixedly mounted on the right side of the fixing base 401, and an emission optical fiber ribbon 408 is fixed into the first optical fiber bracket 407. The optical signals generated by the laser group 403 are transmitted from left to right into the emission optical fiber ribbon 408 in the first optical fiber bracket 407. The emission optical fiber ribbon 408 is optically connected to the optical connection component 900, such that the optical signals are transmitted to the optical connection component 900 via the emission optical fiber ribbon.

The collimating lens group 404 is located in the light exiting direction of the laser group 403. The multi-channel signal light generated by the laser group 403 is converted into multi-channel collimated light by the collimating lens group 404, and the multi-channel collimated light enters the emission optical fiber ribbon 408 in the first optical fiber bracket 407.

The laser group 403 includes a plurality of lasers, and the collimating lens group 404 includes a plurality of collimating lenses. Each laser emits one laser beam, and each collimating lens is in one-to-one correspondence with the lasers and arranged in the light exiting direction of the laser. The collimating lens converts the laser beam emitted by the laser into a collimated beam, and each collimated beam is transmitted into one fiber of the emission optical fiber ribbon 408, so as to achieve multi-channel optical emission.

In some embodiments, the laser group 403 may emit multi-channel same-wavelength signal light, and the multi-channel same-wavelength signal light is transmitted to the host computer 100 via the emission optical fiber ribbon 408 and the optical connection component 900; the laser group 403 may also emit various different-wavelength signal light that is transmitted to the host computer 100 via the emission optical fiber ribbon 408 and the optical connection component 900.

To facilitate transmission of the collimated beams into the fibers of the emission optical fiber ribbon 408, the optical emission assembly further includes a converging lens group 405, where the converging lens group 405 is located between the collimating lens group 404 and the first optical fiber bracket 407 and includes a plurality of converging lenses; and each converging lens is in one-to-one correspondence with the collimating lens and disposed in the light exiting direction of the collimating lens. The converging lens converges the collimated beam output by the collimating lens into the emission optical fiber ribbon 408 in the first optical fiber bracket 407.

In some embodiments, the optical emission assembly further includes an isolator group 406, where the isolator group 406 is located between the converging lens group 405 and the first optical fiber bracket 407 and includes a plurality of isolators. Converging beams output by the converging lenses pass through the isolators and enter the fibers. Some beams are reflected at a fiber end face, and the reflected light is isolated by the isolators and cannot pass through the isolators, so the reflected light does not return to the laser group 403 along an original path, thereby ensuring the emission performance of the laser group 403.

In some embodiments, the laser group 403 further includes a thermoelectric cooler (TEC) 410 adhered to the top surface of the fixing base 401. The TEC 410 is used to support and fix a substrate, and the substrate is used to support and fix the laser group 403 and the collimating lens group 404. Thus, heat generated by the laser is sequentially transferred to the substrate and the TEC 410, and the TEC 410 effectively achieves the heat dissipation of the laser, thereby preventing the temperature of the laser from affecting the wavelength of the emitted beam.

In some embodiments, each laser of the laser group 403 may be mounted on a laser heat sink, the laser heat sink is mounted on the substrate, the substrate is mounted on a cooling surface of the TEC 410, and a heating surface of the TEC 410 is mounted on the top surface of the fixing base 401, so as to adjust the temperature of the laser by the TEC 410.

The TEC 410 can not only adjust a temperature of the laser, but also raise a mounting height of the laser, such that the mounting height of the laser is the same as a height of the front surface of the circuit board 300 to shorten a wire bonding length between the laser and the pad group on the circuit board 300.

In some embodiments, when the TEC 410 is mounted on the top surface of the fixing base 401, a preset gap exists between a left end face of the TEC 410 and a right end face of the limit boss 409, such that the gap between the first limit hole 302 and the first mounting hole 303 is located within the preset gap. This ensures that the limit boss 409 is embedded in the first limit hole 302 and the laser group 403 and the TEC 410 are embedded in the first mounting hole 303.

In some embodiments, a positioning slot may be provided on the top surface of the fixing base 401, and is close to the limit boss 409. A preset gap exists between a left side face of the positioning slot and a right end face of the limit boss 409, and the TEC 410 is mounted in the positioning slot, such that the TEC 410 is mounted on the fixing base 401. This ensures a preset gap between the TEC 410 and the limit boss 409.

FIG. 11 is a structural diagram of a fixing base in an optical module provided according to some embodiments of the present disclosure. As shown in FIG. 11, to enable the optical emission assembly to be mounted and fixed onto the fixing base 401, a mounting boss 412 is formed on the top surface of the fixing base 401. The top surface of the mounting boss 412 protrudes from the top surface of the fixing base 401, the top surface of the limit boss 409 protrudes from the top surface of the mounting boss 412, and the converging lens group 405 and the isolator group 406 are mounted on the top surface of the mounting boss 412.

Since the laser group 403 and the collimating lens group 404 are mounted on the TEC 410, the mounting height of the laser group 403 and the collimating lens group 404 is raised by the TEC 410. In order to ensure the coupling accuracy of the laser beam, the central axes of the laser group 403, the collimating lens group 404, the converging lens group 405, the isolator group 406, and the emission optical fiber ribbon 408 need to coincide. Therefore, the mounting heights of the converging lens group 405 and the isolator group 406 are raised by the mounting boss 412, and the emission optical fiber ribbon 408 is fixed and raised by the first optical fiber bracket 407. Thus, the central axes of the laser group 403, the collimating lens group 404, the converging lens group 405, the isolator group 406, and the emission optical fiber ribbon 408 coincide, thereby improving the coupling accuracy of the optical emission assembly.

Since the width of the first limit hole 302 is less than the width of the first mounting hole 303, the limit boss 409 is embedded in the first limit hole 302, and the fixing base 401 is embedded in the first mounting hole 303. Therefore, the width of the limit boss 409 is less than the width of the fixing base 401.

In some embodiments, since the top surface of the fixing base 401 is adhered and fixed to the back surface of the circuit board 300, and the mounting boss 412 is embedded in the first mounting hole 303, the width of the mounting boss 412 is less than the width of the fixing base 401.

In some embodiments, a first glue guiding slot 414 is further formed in the top surface of the fixing base 401 and located between a right side face of the mounting boss 412 and a right side face of the fixing base 401. The first optical fiber bracket 407 is adhered to the first glue guiding slot 414 with glue. An operator injects the glue into the first glue guiding slot 414, then places the first optical fiber bracket 407 on the fixing base 401. A gap between the first optical fiber bracket 407 and the top surface of the fixing base 401 is filled with the glue in the first glue guiding slot 414, such that the first optical fiber bracket 407 is adhered to the top surface of the fixing base 401.

In some embodiments, the first optical fiber bracket 407 is adhered to the top surface of the fixing base 401, and the isolator group 406 is mounted on the mounting boss 412. To avoid direct contact between the isolator group 406 and the fiber end face, an avoidance boss 413 is provided on the mounting boss 412. The avoidance boss 413 extends from the right end face of the mounting boss 412 in the direction of the first glue guiding slot 414. The width of the avoidance boss 413 is less than or equal to the width of the mounting boss 412, and the height of the avoidance boss 413 is less than the height of the mounting boss 412, thereby facilitating the positioning and mounting of the isolator group 406.

In some embodiments, for ease of processing, the avoidance boss 413 and the mounting boss 412 are integrally formed, where a notch is formed downward from the top surface of the integral boss, and the isolator group 406 is positioned and mounted via the notch.

When the first optical fiber bracket 407 is adhered to the top surface of the fixing base 401, the left end face of the first optical fiber bracket 407 is in contact with the right end face of the avoidance boss 413, such that a gap is formed between the left end face of the first optical fiber bracket 407 and the light exiting end face of the isolator group 406, so as to ensure the coupling efficiency of the fiber.

In some embodiments, an identification surface 415 is formed on the right end face of the fixing base 401 and inclined, such that a corner of the fixing base 401 is missing. The identification surface 415 is used for orientation identification, so as to facilitate identifying the direction in which the fixing base 401 is embedded in the first mounting hole 303, and to facilitate identifying the emission direction of the laser beam.

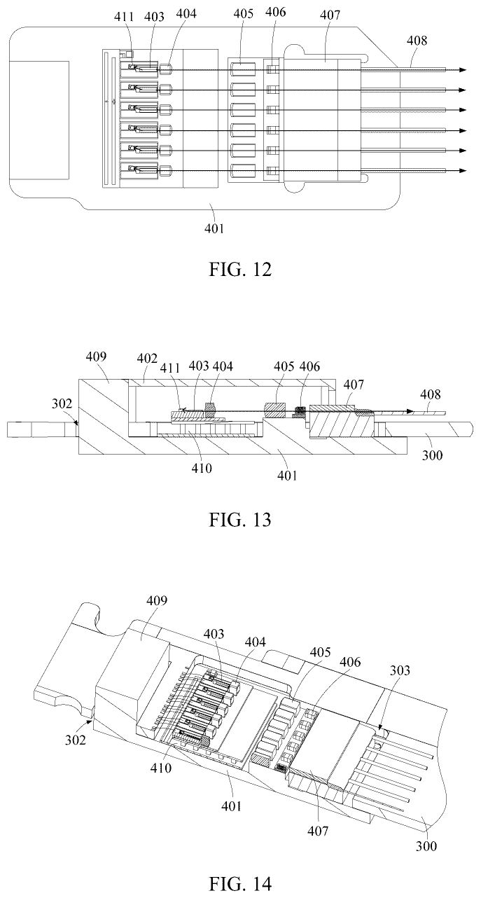

FIG. 12 is a partial top view of an optical emission component in an optical module provided according to some embodiments of the present disclosure; FIG. 13 is a first assembly cross-sectional view of an optical emission component and a circuit board in an optical module provided according to some embodiments of the present disclosure; and FIG. 14 is a second assembly cross-sectional view of an optical emission component and a circuit board in an optical module provided according to some embodiments of the present disclosure; As shown in FIG. 12, FIG. 13, and FIG. 14, in some embodiments of the present disclosure, the TEC 410 is adhered to the top surface of the fixing base 401, the substrate is adhered to the cooling surface of the TEC 410, the laser group 403 is adhered to the substrate, and the collimating lens group 404 is adhered to the substrate along the light exiting direction of the laser. The converging lens group 405 and the isolator group 406 are adhered to the mounting boss 412, and the first optical fiber bracket 407 is adhered to the first glue guiding slot 414, such that a gap is formed between the first optical fiber bracket 407 and the isolator group 406. The optical emission assembly on the fixing base 401 is embedded into the first mounting hole 303 from bottom to top, the limit boss 409 on the fixing base 401 is embedded in the first limit hole 302, and the top surface of the fixing base 401 is adhered and fixed to the back surface of the circuit board 300, such that the fixing base 401 and the optical emission assembly mounted on the fixing base 401 are fixed onto the circuit board 300.

The laser is connected to the first pad group 306 via wire bonding, and the circuit board 300 transmits electrical signals to the laser group 403 via the first pad group 306 and wire bonding, such that the laser group 403 generates multiple laser beams.

The multiple laser beams are converted into multiple collimated beams by the collimating lens group 404, the multiple collimated beams are converted into multiple converging beams by the converging lens group 405, and the multiple converging beams are directly coupled into the emission optical fiber ribbon 408 in the first optical fiber bracket 407 through the isolator group 406. The multiple optical signals are transmitted to the optical connection component 900 via the emission optical fiber ribbon 408, and transmitted to the host computer 100 via the optical connection component 900, so as to achieve multi-channel optical emission.

In some embodiments, the optical emission assembly may not include the first optical fiber bracket 407 and the emission optical fiber ribbon 408. The optical emission assembly includes the laser group 403, the collimating lens group 404, an optical multiplexer, the isolator, the converging lens, and an optical connector. The optical multiplexer is located between the collimating lens group and the isolator. Driven by the electrical signals transmitted by the circuit board 300, the laser group 403 generates multiple laser beams, and the multiple laser beams are converted into multiple collimated beams by the collimating lens group 404. The multiple collimated beams are multiplexed by the optical multiplexer into a composite beam, the composite beam passes through the isolator and is transmitted to the converging lens, the composite beam is converged to the optical connector by the converging lens, and the optical connector is optically connected to the optical connection component 900 via an emission optical fiber, so as to achieve optical connection between the optical emission component and the optical connection component 900.

Referring to FIG. 8, in some embodiments of the present disclosure, the cover 402 is covered on the fixing base 401, such that the optical emission assembly is located in an emission cavity formed by the fixing base 401 and the cover 402. The cover 402 includes a top plate and four side plates connected to the top plate. The four side plates may be arranged on the top surface of the fixing base 401, and the bottom surfaces of the four side plates may be adhered to the top surface of the fixing base 401, such that the fixing base 401 supports and fixes the cover 402.

A first avoidance groove may be formed in the side plate of the cover 402 facing the limit boss 409, and the limit boss 409 is embedded in the first avoidance groove to achieve adhesive fixation between the limit boss 409 and the cover 402; a second avoidance groove is formed in the side plate of the cover 402 opposite to the limit boss 409, and used to accommodate the first optical fiber bracket 407, such that the emission optical fiber ribbon 408 fixed within the first optical fiber bracket 407 passes through the second avoidance groove.

In some embodiments, when the limit boss 409 is embedded in the first avoidance groove, the top plate of the cover 402 may be flush with the top surface of the limit boss 409, or the top plate of the cover 402 may be recessed below the top surface of the limit boss 409. The slot wall of the first avoidance groove may be adhesively fixed to the side face of the limit boss 409, so as to achieve a sealed connection between the cover 402 and the limit boss 409. In some embodiments, the top surface of the limit boss 409 may also be lower than the top plate of the cover 402, and the top plate of the cover 402 may cover the top surface of the limit boss 409, so as to achieve a sealed connection between the cover 402 and the limit boss 409.

In some embodiments, the fixing base 401 may be embedded in the first mounting hole 303, and the limit boss 409 on the fixing base 401 may be embedded in the first limit hole 302, such that the top surface of the fixing base 401 is adhesively fixed to the back surface of the circuit board 300. Then, the TEC 410 is adhered to the top surface of the fixing base 401, the laser group 403 and the collimating lens group 404 are adhered to the cooling surface of the TEC 410 via the substrate, and a preset gap exists between the laser group 403 and the limit boss 409.

The converging lens group 405 and the isolator group 406 are adhered to the mounting boss 412 of the fixing base 401, and the first optical fiber bracket 407 is adhered to the first glue guiding slot 414 in the fixing base 401. Then, the lasers in the laser group 403 are electrically connected to the first pad group 306 on the circuit board 300 via wire bonding, so as to drive the laser group 403 to generate multiple laser beams. Finally, the cover 402 is covered on the fixing base 401, such that the laser group 403, the collimating lens group 404, the converging lens group 405, the isolator group 406, and first optical fiber bracket 407 are arranged in the emission cavity formed by the fixing base 401 and the cover 402.

The multiple laser beams are converted into multiple collimated beams via the collimating lens group 404; the multiple collimated beams are converted into multiple converging beams via the converging lens group 405; and the multiple converging beams pass through the isolator group 406 and are converged into the emission optical fibers in the first optical fiber bracket 407. The multiple beams are transmitted to the optical connection component 900 via the emission optical fiber ribbon, and then further transmitted to the host computer 100 via the optical connection component 900, so as to achieve multi-channel optical emission.

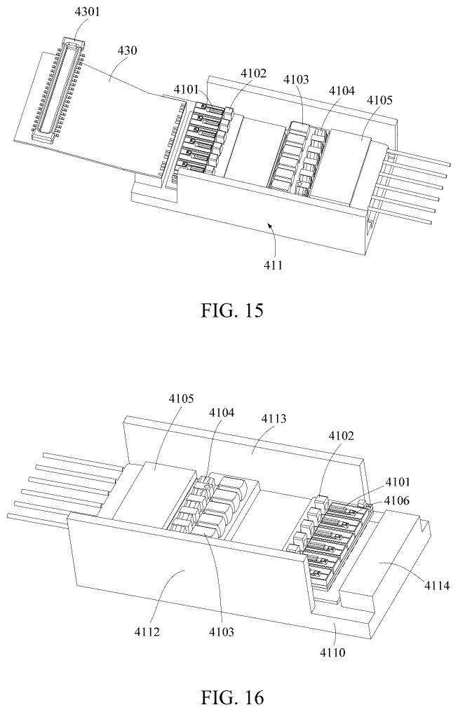

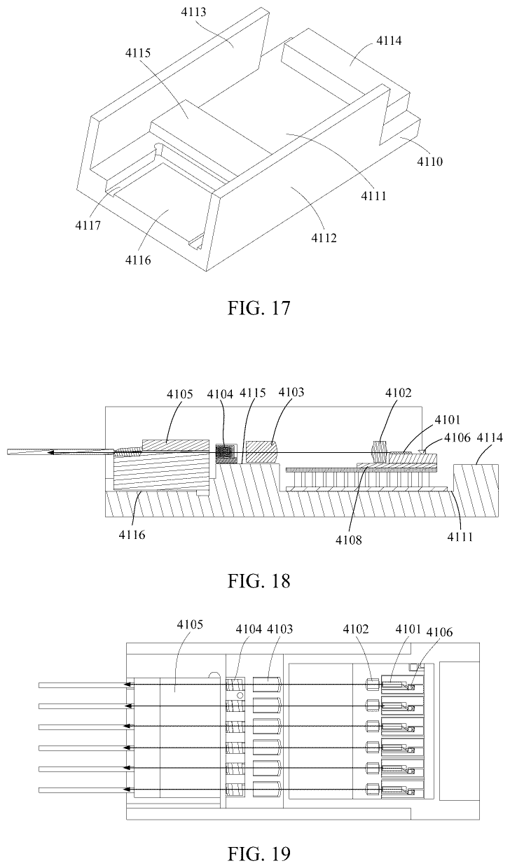

FIG. 15 is another structural diagram of a first optical emission component in an optical module provided according to some embodiments of the present disclosure; FIG. 16 is another partial structural diagram of a first optical emission component in an optical module provided according to some embodiments of the present disclosure; and FIG. 17 is a structural diagram of a first emission housing in an optical module provided according to some embodiments of the present disclosure. As shown in FIG. 15 to FIG. 17, in some embodiments of the present disclosure, the optical component may also be separated from the circuit board, for example, the optical component may be electrically connected to the circuit board via a flexible circuit board. In some examples, the optical component may include two optical emission components, namely a first optical emission component and a second optical emission component, where the first optical emission component may be electrically connected to the circuit board 300 via a first flexible circuit board 430; the first optical emission component further includes a first emission housing 411 and a first optical emission assembly, the first emission housing 411 is covered above the circuit board 300, the first optical emission assembly is mounted in the first emission housing 411, and a gap exists between the first optical emission assembly and the surface of the circuit board 300, such that electrical devices can be arranged on the circuit board 300 corresponding to the gap.

A side of the first flexible circuit board 430 facing away from the circuit board 300 is soldered to one end of the first emission housing 411, and the side of the first flexible circuit board 430 facing the circuit board 300 is provided with pads. The first optical emission assembly is connected to the pads via wire bonding, and the first optical emission assembly generates an optical signal according to the electrical signal transmitted by the first flexible circuit board 430.

In some embodiments, the first optical emission assembly includes a laser group 4101, a collimating lens group 4102, and a second optical fiber bracket 4105; the laser group 4101, the collimating lens group 4102, and the second optical fiber bracket 4105 are sequentially arranged in the left-right direction. The laser group 4101 is located on the left side of the first emission housing 411, such that the laser group 4101 is close to the first flexible circuit board 430, and the mounting height of the laser group 4101 is the same as the that of the first flexible circuit board 430; and the second optical fiber bracket 4105 is located on the right side of the first emission housing 411, and the optical signals generated by the laser group 4101 are transmitted from left to right into the first optical fiber ribbon in the second optical fiber bracket 4105. The first optical fiber ribbon is optically connected to the optical connection component 900, such that the optical signal is transmitted to the optical connection component 900 via the first optical fiber ribbon.

In some embodiments, the second optical emission component may be electrically connected to the circuit board 300 via a second flexible circuit board. The second optical emission component includes a second emission housing and a second optical emission assembly. The second emission housing is covered above the circuit board 300, the second optical emission assembly is mounted in the second emission housing, and a gap exists between the second optical emission assembly and the surface of the circuit board 300, such that the electrical devices can be arranged on the circuit board 300 corresponding to the gap.

A side of the second flexible circuit board facing away from the circuit board 300 is soldered to one end of the second emission housing, and the side of the second flexible circuit board facing the circuit board 300 is provided with pads. The second optical emission assembly is connected to the pads via wire bonding, and the second optical emission assembly generates an optical signal according to the electrical signal transmitted by the second flexible circuit board.

The first emission housing 411 and the second emission housing have a same configuration, and the second optical emission assembly and the first optical emission assembly have a same configuration. The second optical emission assembly is connected to the optical connection component 900 via a second optical fiber ribbon, and the multi-channel signal light generated by the second optical emission assembly is transmitted to the host computer 100 via the second optical fiber ribbon and the optical connection component 900.

FIG. 18 is another cross-sectional view of a first optical emission component in an optical module provided according to some embodiments of the present disclosure. As shown in FIG. 17 and FIG. 18, the first emission housing 411 includes a second top plate 4110, a fifth side plate 4112, and a sixth side plate 4113. One end of the fifth side plate 4112 and one end of the sixth side plate 4113 are respectively fixedly connected to an inner side face of the second top plate 4110. The fifth side plate 4112 and the sixth side plate 4113 are arranged opposite each other, such that the second top plate 4110, the fifth side plate 4112, and the sixth side plate 4113 form a U-shaped shell.

A first boss 4114 is formed at one end of the second top plate 4110 facing the first flexible circuit board 430, where the first boss 4114 extends from a left side face of the second top plate 4110 toward a right side face thereof. A dimension of the first boss 4114 in the left-right direction is less than that of the second top plate 4110 in the left-right direction. A side of the first flexible circuit board 430 is fixedly connected to the first boss 4114, such that the first flexible circuit board 430 is connected to the first emission housing 411 via the first boss 4114.

A first mounting surface 4111 is formed on the inner side face of the second top plate 4110, and located between the first boss 4114 and the right side face of the second top plate 4110. The first mounting surface 4111 is recessed relative to the first boss 4114, and the laser group 4101 is located on the first mounting surface 4111, such that the laser group 4101 is electrically connected to the first flexible circuit board 430 via wire bonding.

Referring to FIG. 18, in some embodiments, the laser group 4101 includes a plurality of laser heat sinks and the plurality of lasers, where one laser is arranged on one laser heat sink and a front surface of the laser faces the collimating lens to emit the laser beam. The laser heat sink is used for heat dissipation of the laser.

The laser group 4101 further includes the substrate 4108 located on the first mounting surface 4111, where the substrate 4108 is used to support the plurality of laser heat sinks and the collimating lens group 4102, that is, the plurality of laser heat sinks and the collimating lens group 4102 may be sequentially adhered to the substrate 4108 via the glue, and the lasers are adhered to the laser heat sinks, such that the laser group 4101 is supported and fixed via the substrate 4108.

In some embodiments, the laser group 4101 further includes the thermoelectric cooler (TEC) adhered to the first mounting surface 4111. The TEC is used to support and fix the substrate 4108. The substrate 4108 is used to support and fix the plurality of laser heat sinks, and the laser heat sinks are used to support and fix the lasers. Thus, heat generated by the lasers is sequentially transferred to the laser heat sinks, the substrate 4108, and the TEC, effectively achieving heat dissipation for the lasers.

The TEC can not only adjust a temperature of the lasers, but also raise a mounting height of the laser, such that the mounting height of the laser is the same as that of the first flexible circuit board 430 to shorten a wire bonding length between the lasers and the first flexible circuit board 430.

A second boss 4115 is further formed on the inner side face of the second top plate 4110, where the first mounting surface 4111 is located between the first boss 4114 and the second boss 4115. A height of the second boss 4115 may be the same as that of the first boss 4114. The converging lens group 4103 and the isolator group 4104 are mounted on the second boss 4115, such that optical axes of the converging lens, isolator, and collimating lens are located in a same plane, and the collimated light emitted by the collimating lens can smoothly pass through the converging lens and the isolator.

A second mounting surface 4116 is further formed on the inner side face of the second top plate 4110, where the second boss 4115 is located between the first mounting surface 4111 and the second mounting surface 4116. The second mounting surface 4116 is recessed relative to the first mounting surface 4111. The second optical fiber bracket 4105 is mounted on the second mounting surface 4116, and the upper part of the second optical fiber bracket 4105 is provided with an optical fiber ribbon, for example, the first optical fiber ribbon. An optical axis of the optical fiber and an optical axis of the isolator are located in a same plane, such that the light passing through the isolator is converged into the optical fiber.

In some embodiments, the second optical fiber bracket 4105 is adhered to the second mounting surface 4116 via the glue. To facilitate glue injection, a second glue guiding slot 4117 is formed in the second mounting surface 4116, surrounding the second mounting surface 4116. The operator injects the glue into the second glue guiding slot 4117, then places the second optical fiber bracket 4105 onto the second mounting surface 4116. A gap between the second optical fiber bracket 4105 and the second mounting surface 4116 is filled with the glue in the second glue guiding slot 4117, such that the second optical fiber bracket 4105 is adhered to the second mounting surface 4116.

FIG. 19 is an emission optical path diagram of a first optical emission component in an optical module provided according to some embodiments of the present disclosure. As shown in FIG. 19, the TEC is adhered to the first mounting surface 4111, the substrate 4108 is adhered to the TEC, the plurality of laser heat sinks are adhered to the substrate 4108, the plurality of lasers are adhered to the plurality of laser heat sinks, and the collimating lens group 4102 is adhered to the substrate 4108 in the light exiting direction of the lasers; then, the converging lens group 4103 and the isolator group 4104 are adhered to the second boss 4115, the second optical fiber bracket 4105 is adhered to the second mounting surface 4116, and the first flexible circuit board 430 is adhered to the first boss 4114. The first flexible circuit board 430 is connected to the laser group 4101 via wire bonding, and the first flexible circuit board 430 is electrically connected to the circuit board 300. The circuit board 300 transmits electrical signals to the laser group 4101 via the first flexible circuit board 430, enabling the laser group 4101 to generate multi-channel different-wavelength light.

The multi-channel different-wavelength light is converted into multiple collimated beams via the collimating lens group 4102, the multiple collimated beams are converted into multiple converging beams via the converging lens group 4103, and the multiple converging beams are directly coupled into the optical fiber ribbon in the second optical fiber bracket 4105 through the isolator group 4104. The multiple optical signals are transmitted to the optical connection component 900 via the optical fiber ribbon, and then transmitted to the host computer 100 via the optical connection component 900, so as to achieve multi-channel optical emission.

Referring to FIG. 16, in some embodiments, to monitor the optical power of emission light from the lasers, the first optical emission assembly further includes a photodetector group 4106, where the photodetector group 4106 includes a plurality of photodetectors. Each photodetector corresponds to one laser, and is located in a backward light exiting direction of the laser, and emission light emitted from a back surface of the laser is collected. Since the optical power of emission light from the front surface of the laser is the same as that from the back surface thereof, the optical power of emission light from the front surface of the laser can be obtained based on the optical power of emission light from the back surface thereof, and the optical power of emission light from the laser can be adjusted as needed.

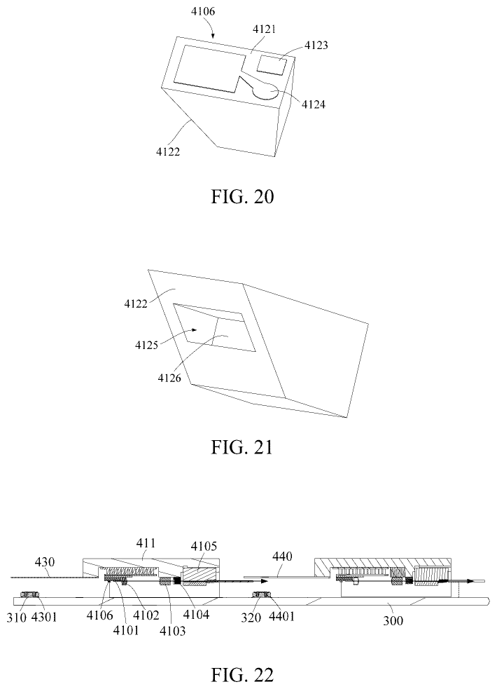

FIG. 20 is a structural diagram of a photodetector in an optical module provided according to some embodiments of the present disclosure; and FIG. 21 is a structural diagram of a photodetector from another angle in an optical module provided according to some embodiments of the present disclosure. As shown in FIG. 20 and FIG. 21, the photodetector includes a bottom surface, a top surface 4121, and an inclined surface 4122. The bottom surface is adhered to the laser heat sink, such that the photodetector is adhered to the laser heat sink. An anode 4124 and a cathode 4123 are formed on the top surface 4121. The anode 4124 and the cathode 4123 are electrically connected to the first flexible circuit board 430 via gold wires, respectively. The photodetector converts collected emission light into electrical signals, where the electrical signals are transmitted to the circuit board 300 via the first flexible circuit board 430, and calculated by the electrical devices on the circuit board 300 to obtain the optical power of emission light from the laser.

In some embodiments, a slot 4125 is formed in the inclined surface 4122, where an opening is formed at one end of the slot 4125 facing the laser. A photosensitive surface 4126 is formed within the slot 4125. When entering the photosensitive surface 4126, the laser beam emitted from the back surface of the laser enters the photodetector through the photosensitive surface 4126, while part of the laser beam may be reflected on the photosensitive surface 4126.

In some embodiments, the photosensitive surface 4126 is inclined. Thus, when the laser beam is reflected on the photosensitive surface 4126, a reflected beam is arranged at a specified angle to an incident beam, and the reflected beam does not return to the laser along an incident optical path, thereby ensuring the light-emitting performance of the laser.

Referring to FIG. 19, in some embodiments, the photodetector is not located directly the back surface of the laser. Since the laser beam emitted from the back surface of the laser is divergent light, a light reception direction of the photodetector is arranged at a preset angle to the backward light exiting direction of the laser, such that part of the laser beam emitted from the back surface of the laser enters the photodetector to prevent the reflected light of the laser beam from the photosensitive surface 4126 from returning to the laser.

In some embodiments, the photodetector is arranged in an offset manner with respect to the backward light exiting direction of the laser, where an offset distance between the photodetector and the backward light exiting direction of the laser is 2-3 mm, such that 1% of the laser beam emitted from the back surface of the laser enters the photodetector, enabling the optical power of emission light from the laser to be monitored in real time via the photodetector.

FIG. 22 is an assembly cross-sectional view of the circuit board, the first optical emission component, and the second optical emission component in the optical module according to some embodiments of the present disclosure. As shown in FIG. 22, the first emission housing 411 of the first optical emission assembly is covered above the circuit board 300, and the first optical emission component of the first optical emission assembly is arranged on the first emission housing 411. A gap exists between the first optical emission component and the surface of the circuit board 300, such that the first optical emission component is flip-mounted on the circuit board 300. A left end of the first flexible circuit board 430 is electrically connected to the circuit board 300, and a right end of the first flexible circuit board 430 is fixed onto the first emission housing 411. The first optical emission assembly is electrically connected to the first flexible circuit board 430 via wire bonding, such that the electrical signals transmitted by the circuit board 300 are transmitted to the first optical emission assembly via the first flexible circuit board 430, to drive the first optical emission component to generate multiple optical signals of different wavelengths that are transmitted to the optical connection component 900 via the first optical fiber ribbon.

The second emission housing of the second optical emission component is covered above the circuit board 300, and the second optical emission assembly of the second optical emission component is arranged on the second emission housing. A gap exists between the second optical emission assembly and the surface of the circuit board 300, such that the second optical emission component is flip-mounted on the circuit board 300. A left end of the second flexible circuit board 440 is electrically connected to the circuit board 300, and a right end of the second flexible circuit board 440 is fixed onto the second emission housing. The second optical emission assembly is electrically connected to the second flexible circuit board 440 via wire bonding, such that the electrical signals transmitted by the circuit board 300 are transmitted to the second optical emission assembly via the second flexible circuit board 440, to drive the second optical emission component to generate multiple optical signals of different wavelengths that are transmitted to the optical connection component 900 via the second optical fiber ribbon.

As shown in FIG. 22, a first electrical connection area and a second electrical connection area are formed on the circuit board 300. The first electrical connection area is located on a left side of the circuit board 300, and the second electrical connection area is located between the first electrical connection area and the golden fingers 301. A first electrical socket 310 is arranged in the first electrical connection area, and electrically connected to the circuit board 300. A second electrical socket 320 is arranged in the second electrical connection area and electrically connected to the circuit board 300.

The first flexible circuit board 430 is provided with a first electrical plug 4301 on a side facing the circuit board 300. Since the first flexible circuit board 430 is flexible, one end of the first flexible circuit board 430 can be bent towards a direction of the circuit board 300, and the first electrical plug 4301 can be inserted into the first electrical socket 310, such that the first flexible circuit board 430 is electrically connected to the circuit board 300 via the first electrical plug 4301 and the first electrical socket 310.

The second flexible circuit board 440 is provided with a second electrical plug 4401 on a side facing the circuit board 300. Since the second flexible circuit board 440 is flexible, one end of the second flexible circuit board 440 can be bent towards the direction of the circuit board 300, and the second electrical plug 4401 can be inserted into the second electrical socket 320, such that the second flexible circuit board 440 is electrically connected to the circuit board 300 via the second electrical plug 4401 and the second electrical socket 320.

It should be understood that, in other examples of the embodiments of the present disclosure, the first socket may also be arranged on the first flexible circuit board, and correspondingly, the first plug may be arranged on the circuit board 300. When the first plug is inserted into the first socket, the first flexible circuit board is electrically connected to the circuit board. In addition, the second socket may also be arranged on the second flexible circuit board, and the second plug may be arranged on the circuit board 300. When the second plug is inserted into the second socket, the second flexible circuit board is electrically connected to the circuit board.

In some embodiments, an optical axis of the first optical emission component 410 and an optical axis of the second optical emission component may be coincident, or an optical axis of the first optical emission component 410 and an optical axis of the second optical emission component may not be coincident, such that the first optical emission component and the second optical emission component are offset, and an optical fiber ribbon of the first optical emission component and an optical fiber ribbon of the second optical emission component are offset, avoiding signal crosstalk caused by the proximity of the optical fibers.

In some embodiments, the first optical fiber ribbon passes through two sides of the second optical emission component and is connected to the optical connection component 900, such that the first optical fiber ribbon avoids the second optical emission component. Compared with the first optical fiber ribbon passing over a top of the second optical emission component, when the first optical fiber ribbon passes through the two sides of the second optical emission component, excessive bending of the first optical fiber ribbon is avoided.

In some embodiments, in the optical module provided by the embodiments of the present disclosure, the optical emission component and/or the optical reception component are connected to the optical connection component 900 via optical fibers, and the optical connection component 900 and the golden fingers 301 are located on a same side (right side) of the optical module. When the optical module 200 is inserted into the host computer 100, the golden fingers 301 on the circuit board 300 are inserted into the electrical connector of the host computer 100, such that the electrical signals from the host computer 100 are transmitted to the circuit board 300 via the golden fingers 301. The optical connection component 900 of the optical module is inserted into the optical connector of the host computer 100, such that the optical signals emitted by the optical emission component are transmitted to the host computer 100 via the optical connection component 900, enabling the host computer 100 to have both optical and electrical functions simultaneously.

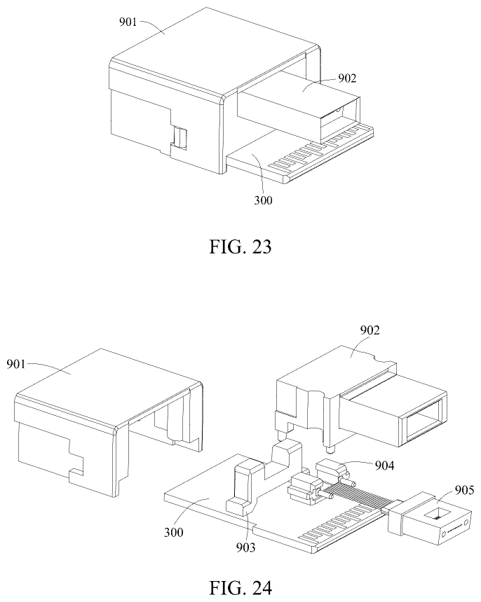

FIG. 23 is a structural diagram of an optical connection component in an optical module provided according to some embodiments of the present disclosure; and FIG. 24 is an exploded view of an optical connection component in an optical module provided according to some embodiments of the present disclosure. As shown in FIG. 23 and FIG. 24, the optical connection component 900 includes an optical fiber fixing member 902, a support bracket 903, a connecting member 904, and a ferrule assembly 905. The optical fiber fixing member 902 is fixed to a right side of the circuit board 300 and is located above the golden fingers 301. The support bracket 903 is adhered to the circuit board 300, and supports the optical fiber fixing member 902, such that the optical fiber fixing member 902 is fixed to the circuit board 300 via the support bracket 903. The connecting member 904 is located within the optical fiber fixing member 902 and fixed inside the optical fiber fixing member 902. The ferrule assembly 905 is inserted into the optical fiber fixing member 902 via the connecting member 904, such that when the optical connection component 900 is inserted into the optical connector of the host computer 100, the ferrule assembly 905 is connected to the plug in the optical connector, to achieve the optical connection between the optical connection component 900 and the optical connector and between the optical module 200 and the host computer 100.

In some embodiments, the optical connection component 900 further includes a cover 901 that is covered above the circuit board 300. The cover 901 encloses the optical fiber fixing member 902. When the upper shell part 201 covers the lower shell part 202, the upper shell part 201 presses against the cover 901, such that the cover 901 the optical fiber fixing member 902 can be steadily mounted through the cover 901.

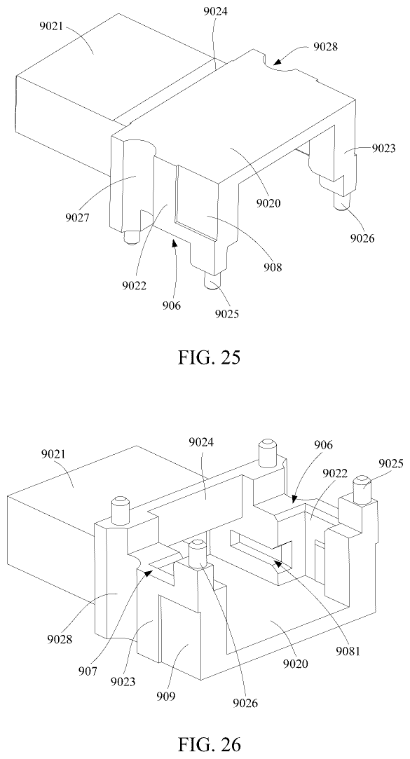

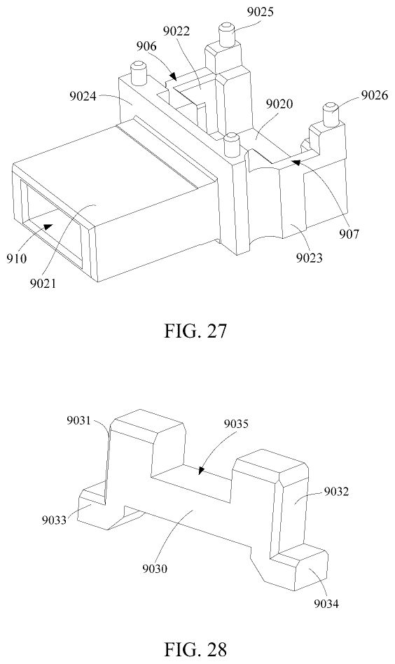

FIG. 25 is a first structural diagram of an optical fiber fixing member in an optical module provided according to some embodiments of the present disclosure; FIG. 26 is a second structural diagram of an optical fiber fixing member in an optical module provided according to some embodiments of the present disclosure; and FIG. 27 is a third structural diagram of an optical fiber fixing member in an optical module provided according to some embodiments of the present disclosure. As shown in FIG. 25 to FIG. 27, the optical fiber fixing member 902 includes a connection part and an insertion part 9021. The connection part faces the optical emission component, and the insertion part 9021 faces the golden fingers 301. The connection part is fixed onto the circuit board 300, and the insertion part 9021 is fixedly connected to the connection part. When the optical connection component 900 is inserted into the optical connector of the host computer 100, the insertion part 9021 is inserted into the optical connector.

The connection part includes a first top plate 9020, a first side plate 9022, a second side plate 9023, and a third side plate 9024. The first side plate 9022, the second side plate 9023, and the third side plate 9024 are respectively fixedly connected to an inner side face of the first top plate 9020. The first side plate 9022 and the second side plate 9023 are arranged opposite each other, and the third side plate 9024 is arranged opposite to a left side face of the first top plate 9020. Thus, the first top plate 9020, the first side plate 9022, the second side plate 9023, and the third side plate 9024 form a square cavity, where openings are formed in left and lower sides of the cavity. The optical fiber ribbon connecting the first optical emission component 410 and the second optical emission component 420 passes through the opening in the left side of the connection part and is inserted into the connection part.

Referring to FIG. 27, a through hole 910 (in some examples, also referred to as a cavity) is formed in the insertion part 9021, and is communicated with the cavity inside the connection part (in some examples, also referred to as an accommodation cavity). The ferrule assembly 905 is inserted into the through hole 910 through an opening in the left side of the connection part, such that when the insertion part 9021 is inserted into the optical connector of the host computer 100, the ferrule assembly 905 is connected with the plug inside the optical connector.

In some embodiments, a first positioning post 9025 is arranged on a side of the first side plate 9022 facing the circuit board 300, a second positioning post 9026 is arranged on a side of the second side plate 9023 facing the circuit board 300, and a third positioning post and a fourth positioning post are arranged on a side of the third side plate 9024 facing the circuit board 300. A plurality of positioning holes are formed in the circuit board 300, where the first positioning post 9025, the second positioning post 9026, the third positioning post, and the fourth positioning post are respectively inserted into the positioning holes. The optical fiber fixing member 902 is fixedly connected to the circuit board 300 through the first positioning post 9025, the second positioning post 9026, the third positioning post, the fourth positioning post, and the plurality of positioning holes. In some embodiments, the first positioning post, the second positioning post, the third positioning post, and the second positioning post may be arranged on the circuit board 300, and correspondingly, positioning holes are arranged in sides of the first side plate 9022, the second side plate 9023, and the third side plate 9024 facing the circuit board 300. The optical fiber fixing member 902 is fixed onto the circuit board 300 through engagement of the positioning posts and the positioning holes.

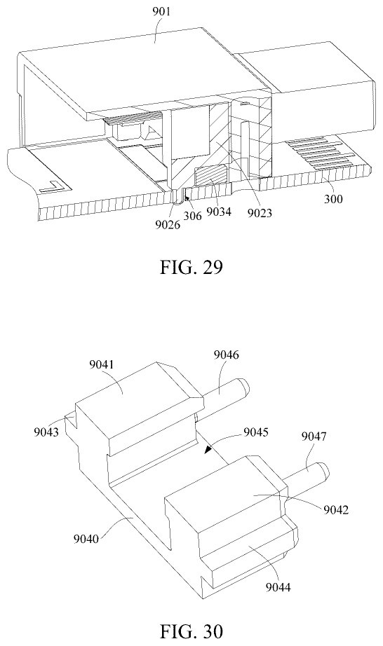

FIG. 28 is a structural diagram of a support bracket in an optical module provided according to some embodiments of the present disclosure; and FIG. 29 is a first cross-sectional view of an optical connection component in an optical module provided according to some embodiments of the present disclosure. As shown in FIG. 28 and FIG. 29, when the optical fiber fixing member 902 is fixedly connected to the circuit board 300 through positioning posts and the positioning holes, to ensure the stability of the optical fiber fixing member 902, the support bracket 903 is mounted inside the cavity between the connection part and the circuit board 300. The support bracket 903 is adhered to the circuit board 300, and the optical fiber fixing member 902 is supported and fixed by the support bracket 903.

The support bracket 903 includes a bracket body 9030, where a bottom surface of the bracket body 9030 may be adhered to the circuit board 300, an avoidance groove 9035 running through the left and right side faces is formed in a top surface of the bracket body 9030. The optical fiber ribbon connecting the optical emission component passes over the avoidance groove 9035 and is inserted into the ferrule assembly 905, such that the optical fiber ribbon is supported by the avoidance groove 9035.

In some embodiments, the bottom surface of the bracket body 9030 may be provided with a first support boss 9033 and a second support boss 9034. The first support boss 9033 and the second support boss 9034 are fixedly connected to a surface of the circuit board 300, such that a specified gap exists between the bottom surface of the bracket body 9030 and the circuit board 300, facilitating the arrangement of the electrical devices and wiring in the gap. This saves the layout space of the circuit board 300.

The bracket body 9030 includes a first side face 9031 and a second side face 9032, where the first side face 9031 and the second side face 9032 respectively face the two lower side plates 2022 of the lower shell part 202. A top surface of the first support boss 9033 is connected to the first side face 9031, and the first support boss 9033 extends from the first side face 9031 toward the lower side plate 2022. A top surface of the second support boss 9034 is connected to the second side face 9032, and the second support boss 9034 extends from the second side face 9032 toward the lower side plate 2022.

Referring to FIG. 25 and FIG. 29, a first notch 906 is formed in a bottom surface of the first side plate 9022, and located between the first positioning post 9025 and the third side plate 9024. A second notch 907 is formed in a bottom surface of the second side plate 9023, and located between the second positioning post 9026 and the third side plate 9024. When the optical fiber fixing member 902 is fixed onto the circuit board 300 through the positioning posts and positioning holes, the top surface of the bracket body 9030 is abutted with the inner side face of the first top plate 9020, the first support boss 9033 is inserted into the first notch 906, and the second support boss 9034 is inserted into the second notch 907, such that the optical fiber fixing member 902 is supported by the support bracket 903.

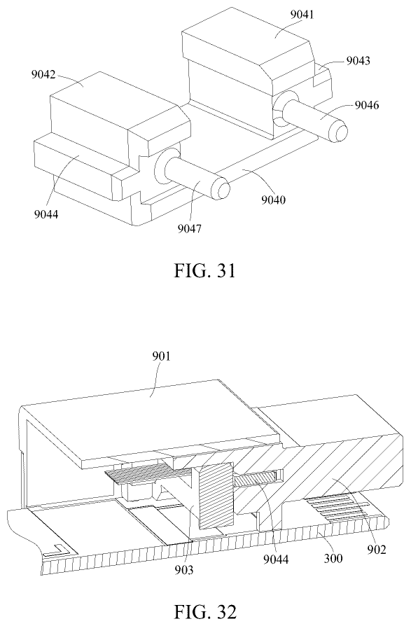

FIG. 30 is a first structural diagram of a connecting member in an optical module provided according to some embodiments of the present disclosure; and FIG. 31 is a second structural diagram of a connecting member in an optical module provided according to some embodiments of the present disclosure. As shown in FIG. 30 and FIG. 31, to facilitate the insertion of the ferrule assembly 905 into the insertion part 9021 of the optical fiber fixing member 902, the connecting member 904 includes a connecting plate 9040, a first mounting block 9041, and a second mounting block 9042. The first mounting block 9041 and the second mounting block 9042 are respectively fixed onto the connecting plate 9040, and the first mounting block 9041 and the second mounting block 9042 are respectively close to the two lower side plates 2022 of the lower shell part 202. An avoidance gap 9045 exists between the first mounting block 9041 and the second mounting block 9042. The first optical fiber ribbon and the second optical fiber ribbon connecting the two optical emission components pass through the avoidance gap 9045 and are inserted into the ferrule assembly 905, so as to avoid the first optical fiber ribbon and the second optical fiber ribbon.

A first pin 9046 is arranged on a right side face (a side face towards the golden finger 301) of the first mounting block 9041, and the first pin 9046 extends from the right side face of the first mounting block 9041 toward the direction of the golden finger 301. A second pin 9047 is arranged on a right side face of the second mounting block 9042, and the second pin 9047 extends from the right side face of the second mounting block 9042 toward the direction of the golden finger 301.

Referring to FIG. 24, pin holes running through the left and right side faces are formed in the ferrule assembly 905. The first pin 9046 and second pin 9047 of the connecting member 904 are respectively inserted into the pin holes of the ferrule assembly 905. A left side face of the ferrule assembly 905 contacts a right side face of the connecting member 904, such that the connecting member 904 and the ferrule assembly 905 are fixedly connected. After the connecting member 904 and the ferrule assembly 905 are fixedly connected, the connecting member 904 is fixed inside the optical fiber fixing member 902, such that the ferrule assembly 905 is located inside the insertion part 9021 of the optical fiber fixing member 902.

Referring to FIG. 30, in some embodiments, a first insertion block 9043 is formed on a side face of the first mounting block 9041 facing one of the lower side plates 2022. The first insertion block 9043 extends from the side face of the first mounting block 9041 toward the direction of the lower side plate 2022, and a dimension of the first insertion block 9043 in the left-right direction is the same as that of the first mounting block 9041 in the left-right direction.

A second insertion block 9044 is formed on a side face of the second mounting block 9042 facing the other lower side plate 2022. The second insertion block 9044 extends from a side face of the second mounting block 9042 toward the direction of the other lower side plate 2022, and a dimension of the second insertion block 9044 in the left-right direction is the same as that of the second mounting block 9042 in the left-right direction.

Referring to FIG. 26, in some embodiments, a first insertion slot 9081 is formed in an inner side face of the first side plate 9022, the first insertion slot 9081 is arranged in the left-right direction, and an opening is formed in a left side face of the first insertion slot 9081. A second insertion slot is formed in an inner side face of the second side plate 9023, a second insertion slot is arranged in the left-right direction, and an opening is formed in a left side face of the second insertion slot.

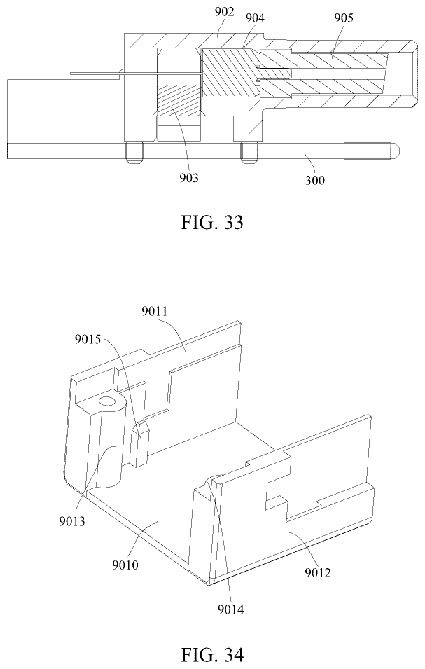

FIG. 32 is a second cross-sectional view of an optical connection component in an optical module provided according to some embodiments of the present disclosure; and FIG. 33 is a third cross-sectional view of an optical connection component in an optical module provided according to some embodiments of the present disclosure. As shown in FIG. 32 and FIG. 33, when the connecting member 904 is fixed in the optical fiber fixing member 902, the first insertion block 9043 is inserted into the first insertion slot 9081, and the second insertion block 9044 is inserted into the second insertion slot, such that the connecting member 904 is fixedly connected to the optical fiber fixing member 902.

In some embodiments, during assembly of the optical connection component 900, the connecting member 904 and the ferrule assembly 905 are fixedly connected through pins and pin holes, and the connecting member 904 and the ferrule assembly 905 are inserted through an opening in a left side of the optical fiber fixing member 902, such that the ferrule assembly 905 is inserted into the insertion part 9021 of the optical fiber fixing member 902. The connecting member 904 is fixed inside the optical fiber fixing member 902 through the insertion block and the insertion slot, such that the optical fiber fixing member 902, the connecting member 904, and the ferrule assembly 905 are assembled.

After the optical fiber fixing member 902, the connecting member 904, and the ferrule assembly 905 are assembled, the support bracket 903 is fixedly mounted on the circuit board 300. Then, the positioning posts at the bottom of the optical fiber fixing member 902 are inserted into the positioning holes in the circuit board 300 until a top surface of the support bracket 903 is abutted with the inner side face of the first top plate 9020, such that the optical fiber fixing member 902 is supported by the support bracket 903, and the optical fiber fixing member 902 and the circuit board 300 are fixed.

In some embodiments, after the connecting member 904 is fixed inside the optical fiber fixing member 902 through the insertion block and the insertion slot, to ensure that the connecting member 904 and the ferrule assembly 905 are steadily installed, a left side face of the connecting member 904 may be adhered to a right side face of the support bracket 903 such that the connecting member 904 is fixed by the support bracket 903.

After the optical connection component 900 is assembled, the first optical fiber ribbon connecting the first optical emission component and the second optical fiber ribbon connecting the second optical emission component respectively pass through the support bracket 903 and the connecting member 904 and then are inserted into the ferrule assembly 905, such that the first optical emission component, the second optical emission component, and the optical connection component 900 are optically connected.

In some embodiments, to protect the optical fiber fixing member 902, the optical connection component 900 further includes a cover 901 that is snapped onto the circuit board 300, where the optical fiber fixing member 902 is arranged inside a cavity formed by the cover 901 and the circuit board 300.

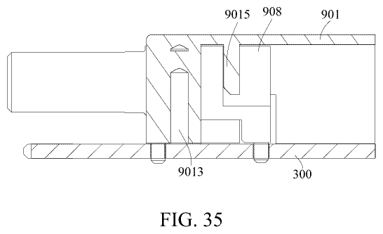

FIG. 34 is a structural diagram of a cover in an optical module provided according to some embodiments of the present disclosure; and FIG. 35 is a third cross-sectional view of an optical connection component in an optical module provided according to some embodiments of the present disclosure. As shown in FIG. 34 and FIG. 35, the cover 901 includes a third top plate 9010, a first side wall 9011, and a second side wall 9012. The first side wall 9011 and the second side wall 9012 are respectively fixedly connected to the third top plate 9010. The first side wall 9011 and the second side wall 9012 are arranged opposite each other. The third top plate 9010, the first side wall 9011, and the second side wall 9012 form a U-shaped cover, such that openings are formed in left and right side faces of the cover 901 to cover the optical fiber fixing member 902 with the cover 901.

In some embodiments, a first positioning component 9013 is formed on an inner side face of the first side wall 9011. The first positioning component 9013 may be a column extending from an inner side face of the third top plate 9010 toward the direction of the circuit board 300. A first limit post 9015 is also formed on the inner side face of the first side wall 9011. The first limit post 9015 extends from the inner side face of the third top plate 9010 toward the direction of the circuit board 300. The first positioning component 9013 and the first limit post 9015 are arranged in the left-right direction.

A second positioning component is formed on an inner side face of the second side wall 9012, and the second positioning component extends from the inner side face of the third top plate 9010 toward the direction of the circuit board 300. A second limit post is also formed on the inner side face of the second side wall 9012. The second limit post extends from the inner side face of the third top plate 9010 toward the direction of the circuit board 300. The second positioning component and the second limit post are arranged in the left-right direction.

Referring to FIG. 25, a first positioning slot 9027 is formed in an outer side face of the first side plate 9022, and the first positioning slot 9027 extends from a top surface of the first top plate 9020 toward the direction of the circuit board 300, and is close to the third side plate 9024. A first limit slot 908 is also formed in the outer side face of the first side plate 9022, the first limit slot 908 is recessed in the outer side face of the first side plate 9022, and openings are formed in an upper side face of the first limit slot 908 and a left side face thereof.

A second positioning slot 9028 is formed in an outer side face of the second side plate 9023, and the second positioning slot 9028 extends from the top surface of the first top plate 9020 toward the direction of the circuit board 300, and is close to the third side plate 9024. A second limit slot 909 is also formed in the outer side face of the second side plate 9023, the second limit slot 909 is recessed in the outer side face of the second side plate 9023, and openings are formed in an upper side face of the second limit slot 909 and a left side face thereof.

When the cover 901 is covered above the optical fiber fixing member 902 from top to bottom, the first positioning component 9013 is inserted into the first positioning slot 9027, and the second positioning component is inserted into the second positioning slot 9028, so as to achieve positioning connection between the cover 901 and the optical fiber fixing member 902. A right side face of the first limit post 9015 is abutted with a right side wall of the first limit slot 908, and a right side face of the second limit post is abutted with a right side wall of the second limit slot 909, such that the cover 901 and the optical fiber fixing member 902 are limited in the left-right direction by the positioning slot and the limit wall.

In some embodiments, a bottom surface of the first positioning component 9013 and a bottom surface 9014 of the second positioning component may be recessed into the bottom surfaces of the first side wall 9011 and the second side wall 9012. When the cover 901 is snapped onto the circuit board 300, the bottom surface of the first positioning component 9013, the bottom surface 9014 of the second positioning component, and the front surface of the circuit board are in contact, and the first side wall 9011 and the second side wall 9012 encloses side walls of the circuit board 300, such that the cover 901 encloses the circuit board 300, facilitating positioning connection of the cover 901.

In some embodiments, the cover 901 may have a larger dimension in the left-right direction than the connection part of the optical fiber fixing member 902 in the left-right direction, and a right side face of the cover 901 may be flush with a right side face of the connection part. When the optical fiber ribbon is inserted into the ferrule assembly 905, the cover 901 can protect the optical fiber ribbon.

In some embodiments, the cover 901 may move independently, or the cover 901 may be fixed onto an inner side face of the upper shell part 201. When the upper shell part 201 covers the lower shell part 202, the cover 901 is snapped onto the optical fiber fixing member 902, such that the cover 901 protects the optical fiber ribbon and the optical fiber fixing member 902.

The optical module provided in the embodiments of the present disclosure includes the upper shell part, the lower shell part, the circuit board, the first optical emission component, the second optical emission component, and the optical connection component, where the upper shell part is covered on the lower shell part, and the upper shell part and the lower shell parts form a cavity only with one opening. The circuit board is located inside the cavity formed by the upper shell part and the lower shell part, and golden fingers on a right side of the circuit board is located at an opening of the cavity. The optical connection component is mounted on the circuit board, and the optical connection component is located at the opening, that is, the optical connection component and the golden finger are positioned on a same side of the circuit board, such that an optical port and an electrical port of the optical module are located at a same opening. The first optical emission component and the second optical emission component are mounted on the circuit board via mounting holes, and are arranged in a left-right direction. Electrical signals transmitted by a host computer are transmitted to the first optical emission component and the second optical emission component via the circuit board, such that the first optical emission component and the second optical emission component generate optical signals.

The first optical emission component is optically connected to the optical connection component via the first optical fiber ribbon, and the second optical emission component is optically connected to the optical connection component via the second optical fiber ribbon. When the optical module is inserted into the host computer, the optical connection component is optically connected to the optical connector inside the host computer, so as to transmit the optical signals generated by the first optical emission component and the second optical emission component to the host computer. The host computer may use the optical signals as its own signal source, or may further branch out an optical fiber to transmit the optical signals to other devices.

For the optical module provided in the embodiments of the present disclosure, the optical port and the electrical port are arranged at a same opening of the optical module. When the optical module is inserted into the host computer, the optical port and the electrical port are respectively connected to the host computer, such that the optical module and the host computer are optically and electrically connected in a single plug-in operation, avoiding coupling between the optical port and the optical fiber, simplifying a coupling process between the optical port of the optical module and the host computer, and improving coupling efficiency.

Finally, it should be noted that the above embodiments are provided merely to illustrate the technical solutions of the present disclosure and not to limit them. Although the present disclosure has been described in detail with reference to the aforementioned embodiments, those of ordinary skill in the art should understand that they can still make modifications on the technical solutions described in the aforementioned embodiments or make equivalent replacements on some of the technical features; and these modifications or replacements do not make the essence of the corresponding technical solutions depart from the spirit and scope of the technical solutions of the various embodiments of the present disclosure.

What is claimed is:

1. An optical module, comprising:
a lower shell part;
an upper shell part that is covered on the lower shell part to form a cavity, the cavity having only one opening;
a circuit board disposed in the cavity, one end of the circuit board being disposed with a golden finger;
an optical component that is electrically connected to the circuit board, the optical component being configured to generate or receive an optical signal;
an optical connection component that is mounted on the circuit board, wherein the optical connection component and the golden finger are located at the opening; the optical connection component is optically connected to the optical component via an optical fiber ribbon; the optical connection component is configured to transmit an optical signal; and wherein the optical connection component comprises:
an optical fiber fixing member comprising a connection part and an insertion part connected to each other, wherein the connection part is mounted on the circuit board, and is formed therein with an accommodation cavity, two ends of the accommodation cavity being formed with insertion openings; the insertion part is formed therein with a cavity that is opened at two ends and is communicated with the accommodation cavity;
a ferrule assembly that is inserted into the cavity through the insertion openings, wherein the optical fiber ribbon passes through the accommodation cavity and is optically connected to the ferrule assembly; and
a connecting member that is inserted in the accommodation cavity through corresponding insertion opening, wherein the connecting member is fixedly connect with the ferrule assembly and is fixed in the accommodation cavity such that the ferrule assembly is mounted in the cavity through the connecting member; the connecting member is formed thereon with an avoidance gap, and the optical fiber ribbon is passed through the avoidance gap.

2. The optical module according to claim 1, wherein the connection part comprises:
a first top plate that faces the upper shell part and is in contact with the upper shell part;
a first side plate that is connected to and supports the first top plate, the first side plate being further fixedly connected to the circuit board;
a second side plate that is connected to and supports the first top plate, the second side plate being further fixedly connected to the circuit board and being arranged opposite to the first side plate;
a third side plate that is connected to and supports the first top plate, the third side plate being further fixedly connected to the circuit board, wherein the insertion part is connected to the third side plate, and one of the insertion openings is formed on the third side plate;
a fourth side plate that is connected to and supports the first top plate, the fourth side plate being further fixedly connected to the circuit board and being arranged opposite to the third side plate, wherein the other of the insertion openings is formed on the fourth side plate; the first top plate, the first side plate, the second side plate, the third side plate and the fourth side plate form the accommodation cavity with the insertion openings at both ends.

3. The optical module according to claim 2, wherein the optical connection component further comprises:
a cover that is covered above the circuit board, wherein the connection part is limit by and connected to the cover and is located within the cover, and the insertion part is located outside the cover.

4. The optical module according to claim 3, wherein the cover comprises a third top plate, a first side wall and a second side wall, wherein an inner side face of the third top plate is abutted with the first top plate; and the first side wall and the second side wall support and connect the third top plate;
a first positioning component is formed on an inner side face of the first side wall, a first positioning slot is formed on an outer side face of the third side plate, and the first positioning component is inserted into the first positioning slot;
a second positioning component is formed on an inner side face of the second side wall, a second positioning slot is formed on an outer side face of the fourth side plate, and the second positioning component is inserted into the second positioning slot.

5. The optical module according to claim 4, wherein a first limit post is formed on the inner side face of the first side wall, a first limit slot is formed on the outer side face of the third side plate, the first limit slot is recessed relative to the outer side face of the third side plate, and a side of the first limit post is abutted with the first limit slot;
a second limit post is formed on the inner side face of the second side wall, a second limit slot is formed on the outer side face of the fourth side plate, the second limit slot is recessed relative to the outer side face of the fourth side plate, and a side of the second limit post is abutted with the second limit slot.

6. The optical module according to claim 2, wherein a first positioning post is disposed on a side of the first side plate facing the circuit board; a second positioning post is disposed on a side of the second side plate facing the circuit board; a third positioning post and a fourth positioning post are disposed on a side of the third side plate facing the circuit board; and the first positioning post, the second positioning post, the third positioning post and the fourth positioning post are inserted into positioning holes on the circuit board to achieve connection between the connection part and the circuit board.

7. The optical module according to claim 6, wherein the optical connection component further comprises:
a support bracket that is mounted on the circuit board, the support bracket being received in the accommodation cavity through an insertion opening at a bottom portion of the accommodation cavity, and the support bracket supports and connects with the first top plate.

8. The optical module according to claim 7, wherein a side of the first side plate facing the circuit board is formed with a first notch, the first notch being located between the first positioning post and the third side plate;
a side of the second side plate facing the circuit board is formed with a second notch, the second notch being located between the second positioning post and the third side plate;
a top surface of the support bracket abuts with an inner side face of the first top plate, and a lower end of the support bracket is inserted in the first notch and the second notch.

9. The optical module according to claim 8, wherein the support bracket comprises a bracket body, a top surface of the bracket body being formed with an avoidance groove, wherein the optical fiber ribbon passes through the avoidance groove and is inserted into the ferrule assembly;
a bottom surface of the bracket body has a first support boss and a second support boss, the first support boss and the second support boss are mounted on the circuit board, a gap existing between the bottom surface of the bracket body and the circuit board; the first support boss is inserted in the first notch, and the second support boss is inserted in the second notch.

10. The optical module according to claim 2, wherein the connecting member comprises:
a connecting plate;
a first mounting block that is located on the connecting plate, wherein a side of the first mounting block facing the golden finger is disposed with a first pin, the first pin being inserted in the ferrule assembly; another side of the first mounting block is disposed with a first insertion block, the first insertion block being inserted in a first insertion slot on an inner side face of the first side plate;
a second mounting block that is located on the connecting plate, wherein a gap exists between the second mounting block and the first mounting block; a side of the second mounting block facing the golden finger is disposed with a second pin, the second pin being inserted in the ferrule assembly; another side of the second mounting block is disposed with a second insertion block; the first mounting block and the second mounting block are located between the first insertion block and the second insertion block; and the second insertion block is inserted in a second insertion slot on an inner side face of the second side plate.

11. The optical module according to claim 1, wherein,
the circuit board is formed therein with a limit hole, a mounting hole and a pad group, wherein the limit hole and the mounting hole are not communicated to each other, and the pad group is located at a side of the mounting hole;
the optical component comprises:
a fixing base that is embedded in the mounting hole, wherein a top surface of the fixing base is adhered to and fixed to a back surface of the circuit board, one end of the fixing base is disposed with a limit boss that is protruded from the top surface of the fixing base, the limit boss being embedded in the limit hole;
an optical assembly that is mounted on the fixing base and is located within the mounting hole, wherein a gap exists between an optical device of the optical assembly and the limit boss, a wire bonding height of the optical device is equal to a mounting height of the pad group, and the optical device is electrically connected to the pad group via wire bonding;
wherein the limit hole and the mounting hole are arranged along a light transmission direction, the mounting hole is located between the limit hole and the golden finger, and the pad group is located between the limit hole and the mounting hole.

12. The optical module according to claim 11, wherein the limit hole comprises a first limit hole and a second limit hole, the mounting hole comprises a first mounting hole and a second mounting hole; the first mounting hole is located between the first limit hole and the golden finger; the first limit hole and the first mounting hole are not communicated to each other; the pad group comprises a first pad group and a second pad group, and the first pad group is located between the first limit hole and the first mounting hole;
the second limit hole is located between the first mounting hole and the golden finger, the second mounting hole is located between the second limit hole and the golden finger, the second limit hole and the second mounting hole are not communicated to each other, and the second pad group is located between the second limit hole and the second mounting hole;
the optical component comprises a first optical emission component and a second optical emission component, wherein a limit boss of the first optical emission component is embedded in the first limit hole; a fixing base of the first optical emission component is embedded in the first mounting hole; and a laser of the first optical emission component is electrically connected to the first pad group via wire bonding; and

13. The optical module according to claim 12, wherein the fixing base is disposed thereon with a mounting boss and an avoidance boss that are connected to each other, and wherein the mounting boss is located between the limit boss and the avoidance boss, a top surface of the avoidance boss is protruded relative to the top surface of the fixing base, a top surface of the mounting boss is protruded relative to the top surface of the avoidance boss, a top surface of the limit boss is protruded relative to the top surface of the mounting boss, and a laser connected to the first pad group via wire bonding is located between the limit boss and the mounting boss;
the first optical emission component and the second optical emission component have the same configuration, optical assembly of the first optical emission component comprises a converging lens group, an isolator group and a first optical fiber bracket, wherein the converging lens group and the isolator group are mounted on the mounting boss, the first optical fiber bracket is mounted on the fixing base, and the first optical fiber bracket abuts against the avoidance boss such that a gap exists between the first optical fiber bracket and the isolator group.

14. The optical module according to claim 12, wherein a width of the first mounting hole is greater than a width of the first limit hole, and a length of the first mounting hole is greater than a length of the first limit hole;
a width of the second mounting hole is greater than a width of the second limit hole, and a length of the second mounting hole is greater than a length of the second limit hole;
or, the width of the first limit hole is equal to the width of the second limit hole, and the length of the first limit hole is equal to the length of the second limit hole;
the width of the first mounting hole is equal to the width of the second mounting hole, and the length of the first mounting hole is equal to the length of the second mounting hole;
wherein central axes of the first limit hole, the first mounting hole, the second limit hole and the second mounting hole do not coincide with a central axis of the circuit board.

15. The optical module according to claim 1, wherein the optical component comprises a first optical emission component and a second optical emission component, the optical fiber ribbon comprises a first optical fiber ribbon and a second optical fiber ribbon; the optical connection component is optically connected to the first optical emission component via the first optical fiber ribbon, and is optically connected to the second optical emission component via the second optical fiber ribbon; and the first optical fiber ribbon passes through two sides of the second optical emission component and is connected to the optical connection component.

16. The optical module according to claim 15, wherein,
the first optical emission component comprises:
a first emission housing that is covered above the circuit board;
a first optical emission assembly that is mounted in the first emission housing, the first optical emission assembly being configured to generate an optical signal;
a first flexible circuit board, one end of the first flexible circuit board being fixed to the first emission housing, the other end of the first flexible circuit board being electrically connected to the circuit board, and the first optical emission assembly being wire-bonded to the first flexible circuit board;
the second optical emission component comprises:
a second emission housing that is covered above the circuit board;
a second optical emission assembly that is mounted in the second emission housing, the second optical emission assembly being configured to generate an optical signal;
a second flexible circuit board, one end of the second flexible circuit board being fixed to the second emission housing, the other end of the second flexible circuit board being electrically connected to the circuit board, and the second optical emission assembly being wire-bonded to the second flexible circuit board.

17. The optical module according to claim 16, wherein the first emission housing comprises:
a second top plate that faces a front surface of the circuit board, wherein the first optical emission assembly is mounted on the second top plate; one end of the first flexible circuit board is fixedly connected to the second top plate; a first boss is formed on the second top plate at one end of the second top plate, and a side of the first flexible circuit board facing away from the circuit board is fixedly connected to the first boss;
a fifth side plate that is located on the circuit board, the fifth side plate supporting the second top plate; and
a sixth side plate that is located on the circuit board, the sixth side plate being arranged opposite to the fifth side plate and supporting the second top plate.

18. The optical module according to claim 17, wherein the second top plate further comprises:
a first mounting surface that is arranged on the second top plate and recessed relative to the first boss;
a second boss that is arranged on the second top plate, the first mounting surface being located between the first boss and the second boss, and the second boss being protruded relative to the first mounting surface; and
a second mounting surface that is arranged on another end of the second top plate, the second boss being located between the first mounting surface and the second mounting surface, and the second mounting surface being recessed relative to the first mounting surface;
the first optical emission assembly comprises:
a laser group comprising a plurality of laser heat sinks mounted on the first mounting surface and a plurality of lasers mounted on the laser heat sinks, wherein the lasers are wire-bonded to the flexible circuit board and are configured to generate signal lights;
a collimating lens group that is mounted on the first mounting surface in a light exiting direction of the laser group, the collimating lens group being configured to convert the signal lights generated by the lasers into collimated lights;
a converging lens group that is mounted on the second boss, the converging lens group being configured to convert the collimated lights into converged lights; and
an optical fiber bracket that is mounted on the second mounting surface, wherein the first optical fiber ribbon is located in the optical fiber bracket, and the converged lights are coupled into the first optical fiber ribbon.

19. The optical module according to claim 18, wherein the first optical emission assembly further comprises:
a photodetector group of a plurality of photodetectors, wherein photosensitive surfaces of the photodetectors are located in a backward light exiting direction of the lasers, and light reception directions of the photodetectors are arranged at a preset angle to the backward light exiting direction of the lasers;
a misalignment distance between the photodetectors and the backward light exiting direction of the lasers is 2 to 3 mm.

20. The optical module according to claim 16, wherein a first electrical socket is disposed on and electrically connected to the circuit board;
a first electrical plug is disposed at a side of the first flexible circuit board facing the circuit board, the first electrical plug being inserted into the first electrical socket such that the first flexible circuit board is electrically connected to the circuit board.
